(19) United States
(12) Patent Application Publication
(10) Pub. No.: US 2018/0196914 A1
(43) Pub. Date: Jul. 12, 2018

(54) VIRTUAL CELL SIMULATOR

(71) Applicants: Mohammad Reza Ejtehadi, Tehran (IR); Maziar Heidari, Arak (IR); Tiam Heydari, Tehran (IR); Morteza Mahmoudi, Tehran (IR)

(72) Inventors: Mohammad Reza Ejtehadi, Tehran (IR); Maziar Heidari, Arak (IR); Tiam Heydari, Tehran (IR); Morteza Mahmoudi, Tehran (IR)

(21) Appl. No.: 15/915,044

(22) Filed: Mar. 7, 2018

Related U.S. Application Data
(60) Provisional application No. 62/467,839, filed on Mar. 7, 2017.

(51) Int. Cl. G06F 19/12

(52) U.S. Cl. CPC G06F 19/12

(57) ABSTRACT

A virtual cell simulator for generating virtual cell models is disclosed. The virtual cell simulator can be configured to model cells with a variety of different characteristics while adsorbing on various types of substrates. In some cases, the simulation technique can apply Molecular Dynamics. Furthermore, the simulation technique can implement Multi Particle Collision Dynamics to provide a powerful mesoscopic method for simulation of solvents. The virtual cell simulator provides a highly reliable means of predicting cell behavior prior to experimental evaluation. The virtual cell includes components that represent or virtually model outer membranes, nucleus membranes, cytoplasm, cytoskeleton, and/or chromatin fibers.

### CROSS-REFERENCE TO RELATED APPLICATION

This application claims the benefit of priority from pending U.S. Provisional Patent Application Ser. No. 62/467,839, filed on Mar. 7, 2017, and entitled “VIRTUAL CELL SIMULATOR” which is incorporated herein by reference in its entirety.

### BACKGROUND

Stem cells are undifferentiated biological cells that can differentiate into specialized cells and can divide to produce more stem cells. They are found in multicellular organisms. In mammals, there are two broad types of stem cells: embryonic stem cells, which are isolated from the inner cell mass of blastocysts, and adult stem cells, which are found in various tissues. In adult organisms, stem cells and progenitor cells act as a repair system for the body, replenishing adult tissues. In a developing embryo, stem cells can differentiate into specialized cells as well as help maintain the normal turnover of regenerative organs, such as blood, skin, or intestinal tissues.

The cell cytoskeleton and scaffold structure of stem cells are less developed than that of other functional or differentiated cells. Furthermore, stem cells are generally more symmetrical in terms of their appearance and mechanical properties, relative to differentiated cells. One of the primary features of stem cells is their ability to differentiate into the reference tissue in which they are placed. For example, if a stem cell is injected into the heart tissue, the stem cell becomes a tissue of the heart muscle. The process through which this occurs remains unclear. The same process can also occur when stem cells are placed into other tissues such as bone, liver, skin and even neural tissues. While attempts to understand the process by which the stem cells identify a reference tissue have continued, there is no definitive answer as of yet.

One of the most difficult challenges in this field is determining and elucidating the living state of cells. Current knowledge and technology is not yet capable of measuring the forces governing living cells. A number of experiments and simulations have been designed and conducted which attempt to describe observations as to the nature and form of the nucleus within the cell, but many questions remain.

Hence, there is a need for a virtual cell model that can be used to determine a living cell's behavior, and more particularly, the behavior of stem cells. There is also a need to integrate an understanding of the various components and parts of a cell to establish a three-dimensional (3D) cell model that may be relied by computer software for facilitating further studies and simulations of cells behavior. Moreover, there is a need for the development of a 3D cell model within a particular environment to help predict cell configurations and changes while interacting with a substrate, other cells, and various other environmental factors.

### SUMMARY

This summary is intended to provide an overview of the subject matter of this patent, and is not intended to identify essential elements or key elements of the subject matter, nor is it intended to be used to determine the scope of the claimed implementations. The proper scope of this patent may be ascertained from the claims set forth below in view of the detailed description below and the drawings.

In one general aspect, the present disclosure is directed to a method for generating a three-dimensional virtual cell model using a virtual cell simulator. The method includes receiving a plurality of cell input parameters specifying properties of a virtual cell to be included in the virtual cell model, receiving a substrate pattern specifying an arrangement of a substrate to be included in the virtual cell model, and generating a first data set that includes initial values for the virtual cell model, the first data set including a three-dimensional model of a cell membrane of the virtual cell, a three-dimensional model of a nucleus membrane of the virtual cell, and a three-dimensional cytoskeleton network including joints with regions of the cell membrane and regions of the nucleus membrane. The method further includes calculating a configuration of the nucleus membrane by simulating physical interactions for a series of time steps between at least the substrate, cell membrane, cytoskeleton network, and nucleus membrane of the virtual cell model, and outputting the calculated configuration of the nucleus membrane

The above general aspect may include one or more of the following features. As one example, the plurality of cell input parameters can include values representing a cell radius and a nucleus radius. In another example, the plurality of cell input parameters may include values representing a bending rigidity of a lipid membrane of a cell and a bending rigidity of a nucleus membrane. In some implementations, the substrate pattern is obtained using a scan of a substrate. The method can also include receiving a value for effective forces produced by actin polymerization in cell edges. In some cases, the method also involves selecting a cytoskeleton type from a group consisting of a viscoelastic model, a passive cable network model, and an active cable network model. In another example, the method includes receiving a topology file including a configuration of an extra cellular matrix, the configuration including values identifying an elasticity of the extra cellular matrix. In one implementation, the cell input parameters include values representing chromatin fibers. In other implementations, the virtual cell simulator includes a simulation box, and the simulation box includes data describing a plurality of solvents and boundary conditions of associated solvent containers. The method may also include initializing a membrane by opening a topology file including membrane node position vectors and coordinates, allocating memory for storing the topology file, and generating vectors of membrane velocities and membrane forces.

In another general aspect, the present disclosure is directed to a system for generating a three-dimensional virtual cell model. The system includes one or more processors, as well as one or more non-transitory computer readable media. The non-transitory computer readable media include instructions which, when executed by the one or more processors, cause the one or more processors to receive a plurality of cell input parameters specifying properties of a virtual cell to be included in the virtual cell model, receive a substrate pattern specifying an arrangement of a substrate to be included in the virtual cell model, generate a first data set that includes initial values for the virtual cell model, the first data set including a three-dimensional model of a cell membrane of the virtual cell, a three-dimensional model of a nucleus membrane of the virtual cell, and a three-dimensional cytoskeleton network including joints with regions of the cell membrane and regions of the nucleus membrane, calculate a configuration of the nucleus membrane by simulating physical interactions for a series of time steps between at least the substrate, cell membrane, cytoskeleton network, and nucleus membrane of the virtual cell model, and output the calculated configuration of the nucleus membrane.

The above general aspect may include one or more of the following features. As one example, the plurality of cell input parameters includes values representing a cell radius and a nucleus radius. In another example, the plurality of cell input parameters includes values representing a bending rigidity of a lipid membrane of a cell and a bending rigidity of a nucleus. In some cases, the substrate pattern is obtained using a scan of a substrate. In one implementation, the instructions further cause the one or more processors to receive a value for effective forces produced by actin polymerization in cell edges. In other implementations, the instructions further cause the one or more processors to select a cytoskeleton type from a group consisting of a viscoelastic model, a passive cable network model, and an active cable network model. In some implementations, the instructions further cause the one or more processors to receive a topology file including a configuration of an extra cellular matrix, the configuration including values identifying an elasticity of the extra cellular matrix. In another implementation, the cell input parameters include values representing chromatin fibers. As another example, the virtual cell simulator can include a simulation box, and the simulation box includes data describing a plurality of solvents and boundary conditions of associated solvent containers. In one example, the instructions further cause the one or more processors to initialize a membrane by opening a topology file including membrane node position vectors and coordinates, allocating memory for storing the topology file, and generating vectors of membrane velocities and membrane forces.

### BRIEF DESCRIPTION OF THE DRAWINGS

FIG. 1A is a schematic overview of an implementation of a virtual cell simulating system;

FIG. 1B is an image of an implementation of a simulated virtual cell model, including a cell membrane, a nucleus membrane, a cytoskeleton network, and chromatin fiber(s) inside the nucleus membrane;

FIG. 1C is a schematic view of an implementation of a virtual cell simulating system configured to simulate the behavior of a living cell during interaction with a substrate;

FIG. 1D illustrates an implementation of an input and output of a virtual cell simulating system, and a comparison between a virtual result from the virtual cell simulator and an experimental result from an actual cell;

FIG. 1E illustrates an implementation of an input and output of a virtual cell simulating system, and a comparison between a virtual result from the virtual cell simulator and an experimental result from an actual cell;

FIG. 2A illustrates an implementation of a simulated cell membrane or cell nucleus membrane, two normal vectors of neighboring elements, and bond flipping between two neighboring triangles;

FIG. 2B illustrates an implementation of a simulated cytoskeleton of the cell;

FIG. 2C illustrates an implementation of the force generated by a single linkage (bond) between two cytoskeleton nodes i and j;

FIG. 2D illustrates an implementation of the angle between two neighboring bonds;

FIG. 2E illustrates an implementation of a simulation box discretized into cubic lattices and solvent particles streaming freely inside and between lattice grids;

FIG. 3 illustrates a flow diagram of an implementation of an overall structure of the software;

FIGS. 4A-4G illustrates a flow diagram of an implementation of parameters that a user enters at the beginning of a simulation;

FIG. 5 illustrates a flow diagram of an implementation of inner parts of the block that initializes the computational materials for the simulation and includes five subroutines;

FIG. 6 illustrates a flow diagram of an implementation of a subroutine that results in initialization of the simulation materials of the cell membrane;

FIG. 7 illustrates a flow diagram of an implementation of a subroutine that results in initialization of the simulation materials of the cell cytoskeleton network;

FIG. 8 illustrates an implementation of a subroutine configured to initialize the simulation materials of the chromatin fibers in the cell from a topology file or creates a new confined chromatin fibers profile with suitable molecular dynamics simulation if no topology file is available;

FIG. 9 illustrates a flow diagram of an implementation of a subroutine that results in initialization of the simulation materials of the ECM or substratum;

FIG. 10 illustrates a flow diagram of an implementation of a subroutine that initializes the simulation materials of the solvent;

FIG. 11 illustrates an implementation of a series of subroutines in a Molecular Dynamics loop configured to generate the body of the simulator;

FIG. 12 illustrates a flow diagram of an implementation of a first phase of Velocity-Verlet integration method;

FIG. 13 illustrates an implementation of a series of subroutines configured to generate the body of force calculator;

FIG. 14 illustrates a flow diagram of an implementation of a subroutine responsible for calculating the internal forces of membranes;

FIG. 15 illustrates a flow diagram of an implementation of a subroutine configured to compute the internal forces of cytoskeleton;

FIG. 16 illustrates a flow diagram of an implementation of a subroutine configured to compute the internal forces of chromatin fibers;

FIG. 17 illustrates a flow diagram of an implementation of a subroutine configured to compute the internal forces of extra-cellular matrix (ECM);

FIG. 18 illustrates a flow diagram of an implementation of a subroutine configured to compute the external forces on solvent;

FIGS. 19A-19B illustrates a flow diagram of an implementation of a subroutine configured to compute the interaction forces between cell membrane and cytoskeleton;

FIG. 20 illustrates a flow diagram of an implementation of a subroutine configured to compute the interaction forces between cell membrane and the chromatin fibers;

FIG. 21 illustrates a flow diagram of an implementation of a subroutine configured to compute the interaction forces between the cell membrane and the extra-cellular matrix (ECM);

FIG. 22 illustrates a flow diagram of an implementation of a subroutine configured to compute the interaction forces between cytoskeleton and the extra cellular matrix (ECM);

FIG. 23 illustrates a flow diagram of an implementation of a subroutine responsible for a collision step between a solvent, membrane, and chromatin fibers;

FIG. 24 illustrates a flow diagram of an implementation of a second phase of the Velocity-Verlet integration method;

FIG. 25 illustrates a flow diagram of an implementation of a subroutine configured to carry out attempts of Monte Carlo bond flipping in the triangulated meshes of the membranes;

FIG. 26 illustrates a flow diagram of an implementation of a subroutine responsible for imposing a velocity-rescaling thermostat to the system;

FIG. 27 illustrates a flow diagram of an implementation of a subroutine configured to save vital information during the simulation;

FIG. 28 illustrates a flow diagram of an implementation of a subroutine configured to finalize stored information during the simulation and save the finalized information as outputs;

FIGS. 29A-29H illustrate the capability of the developed model for predicting cell elongation on the grooved substrates;

FIG. 30A-30K illustrate the virtual cell's response to ECM elasticity;

FIG. 31A-30B illustrate the ability of a virtual cell to accurately predict the geometry of cultured MSCs; and

FIG. 32 is a block diagram showing an implementation of a computer system.

### DETAILED DESCRIPTION

Cells can sense and respond to changes in the topographical, chemical, and mechanical information in their environment. Engineered substrates are increasingly being developed that exploit these physical attributes to direct cell responses (most notably mesenchymal stem cells) and therefore control cell behavior toward desired applications. However, there are very few methods available for robust and accurate modeling that can predict cell behavior prior to experimental evaluations, and this typically means that many cell test iterations are needed to identify best material features.

Physical, chemical, and mechanical properties of the extracellular matrix (ECM) in different tissues have crucial roles in directing residential cell functions. As a result of progress in engineering, biocompatible materials with tunable properties and patterns have been developed and employed to mimic particular ECM characteristics that control cell functions. During recent years, engineered substrates, such as those with micropatterns and/or nanopatterns, have been increasingly applied to trigger a range of cell functions/characteristics including cell alignment (contact guidance) and differentiation. Some examples include nanoscale features that direct differentiation of mesenchymal stem cells (MSCs) toward the osteoblast lineage and variation of material surface mechanical properties guiding stem cell lineage.

It is generally understood that the function of an MSC closely follows form and that the degree of cell spreading is strongly correlated to phenotype. As one example, adipocytes include a low-adhesion and poorly spread MSC phenotype that is associated with little cytoskeletal tension. On the other hand, osteoblasts are typically well-spread MSC derivatives with high levels of cytoskeletal tension, supported by the formation of supermature adhesions. In this case, the MSC phenotype itself is maintained by intermediate levels of intracellular tension and spreading, between the spreading states of fibroblasts and adipocytes. In addition, if MSCs are placed onto substrates imprinted with the morphologies of mature MSC derivative phenotypes, then they are observed to adopt those phenotypes. As one example, they may adopt the phenotype of chondrocytes. More specifically, if the cells are grown of morphological imprints of naïve stem cells, then they retain a MSC phenotype for a longer duration in culture. This morphological control has generated interest in high-throughput materiomics, as well as in screening technologies for chemical, mechanical, and topographical substrate functionalizations. However, the benefits of a predictive modeling simulation would provide a far more powerful, economical, and efficient tool.

The following disclosure presents a unifying computational framework that can generate or facilitate the generation of a multicomponent cell model. The model is configured to predict changes in whole cell and cell nucleus characteristics (in terms of shape, direction, and even chromatin conformation) on a range of cell substrates. Implementations of a multicomponent cell model, referred to herein as a “virtual cell model” or “virtual cell simulator” can be used to predict cell behavior on substrates with a wide range of characteristics. In some implementations, the model can provide highly accurate and reliable information with respect to cell, nucleus, and/or chromatin conformations, in response to different material characteristics. The artificial or virtual cell, as will be described below, includes components that represent or virtually model outer membranes, nucleus membranes, cytoplasm, cytoskeleton, and/or chromatin fibers. In some implementations, a virtual substrate is also utilized for use in conjunction with the virtual cell to allow for the application of a variety of different morphological (topographical) and elastic characteristics. In different implementations, the virtual cell model described herein has the capacity not only to predict shape and conformation of the cells qualitatively but also to generate quantitative results when adequate or appropriate parameters are provided. Aspects, features, characteristics, quantities, algorithms, data, and other parameters of the following disclosure may also be found in Appendix A, “Development of a Virtual Cell Model to Predict Cell Response to Substrate Topography,” Tiam Heydari, Maziar Heidari, Omid Mashinchian, Michal Wojcik, Ke Xu, Matthew John Dalby, Morteza Mahmoudi, and Mohammad Reza Ejtehadi, ACS Nano 2017 11 (9), 9084-9092, which is herein incorporated by reference in its entirety.

In different implementations, the simulation described below can be used across a wide range of cellular types and environments. Thus, in contrast to packages designed by various scientific groups that are built to solve very particular problems, or simulators that concentrate on minimizing calculations, and/or are restricted to two-dimensional (2D) interaction studies, the virtual cell simulator described herein can be used to solve a range of problems in a virtual 3D environment.

Furthermore, in different implementations, the virtual cell simulator utilizes a molecular dynamics (MD) method to modify the simulator. In some implementations, the simulator can supply or be used to mimic or simulate many different environments. This feature permits the model to be used to study the behavior of living cells (a) while the cells are suspended to a substrate, (b) while the cells are attached to a substrate, and/or (c) after the cells have been attached to a substrate. Thus, in different implementations, the cell can also be studied alongside a substrate. In some cases the attachment process can be monitored and the chemical and mechanical properties of the substrate may be customized by the user. Some implementations of the simulator described herein may also be used to study arbitrary problems that benefit from the tools provided in the simulator (or are further developed by the user). As an example, one may study the collision of an object (with any shape) and a wall with different mechanical properties (viscoelastic or otherwise) using disclosed simulator. In some implementations, the simulator may be modified to simulate the behavior of multiple cells on a substrate or in a confinement.

Some virtual cell model implementations disclosed herein are based at least in part on the physical rules and mechanical properties of the cell. For example, in different implementations, the cells may include a wide range of sizes as well as a broad range of nucleus to cell radius ratios. In addition, in some implementations, the cells can be customized to contain any number of chromatin fibers within the nucleus. Therefore, this model can be configured to provide an appropriate, realistic, or customized environment for investigation of cell behavior in different configurations of a substrate on which the cell is located.

Furthermore, in some implementations, the virtual cell model can determine which mechanical properties and/or biological properties are the source of an observed cell behavior. For example, one important phenomenon is the influence of a substrate on the environment of a cell, which has yet to be fully understood. In order to learn more about this phenomenon, the present simulator and model was configured to measure the effect of the substrate on the shape of the cell nucleus as well as investigate the changes induced by the substrate on the configurations of the chromatins inside the nucleus. The results were verified by experiments and are a major step forward in examining the mechanical role of the substrate in cell nucleus configurations. Other examples will also be provided below, where modeling data were correlated with cell culture experimental outcomes in order to confirm the applicability of the virtual cell model and demonstrating the ability to reflect the qualitative behavior of mesenchymal stem cells. Thus, the disclosed simulator provides a reliable, efficient, and fast high-throughput approach for the development of optimized substrates for a broad range of cellular applications including stem cell differentiation.

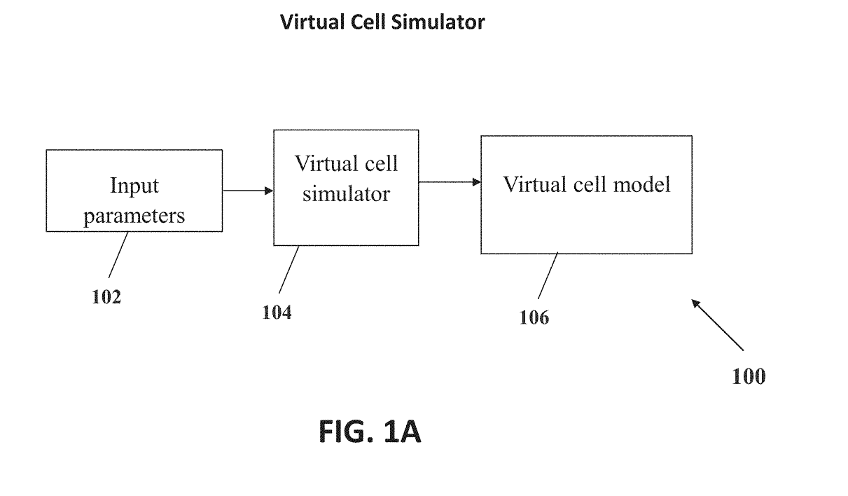

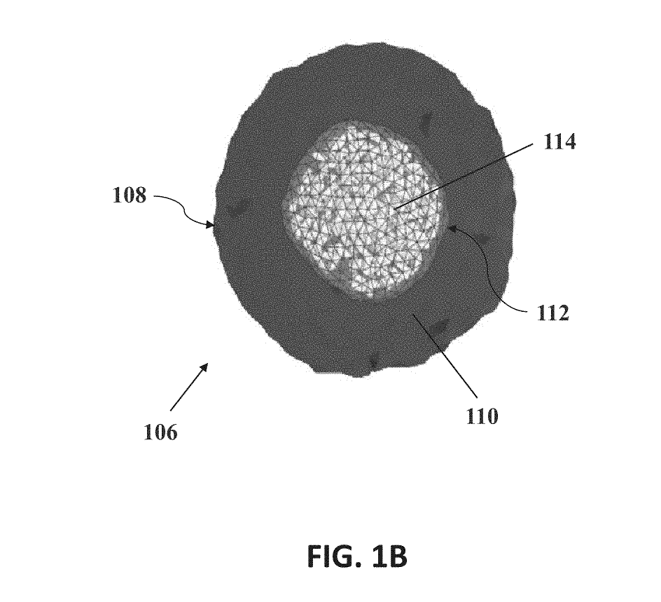

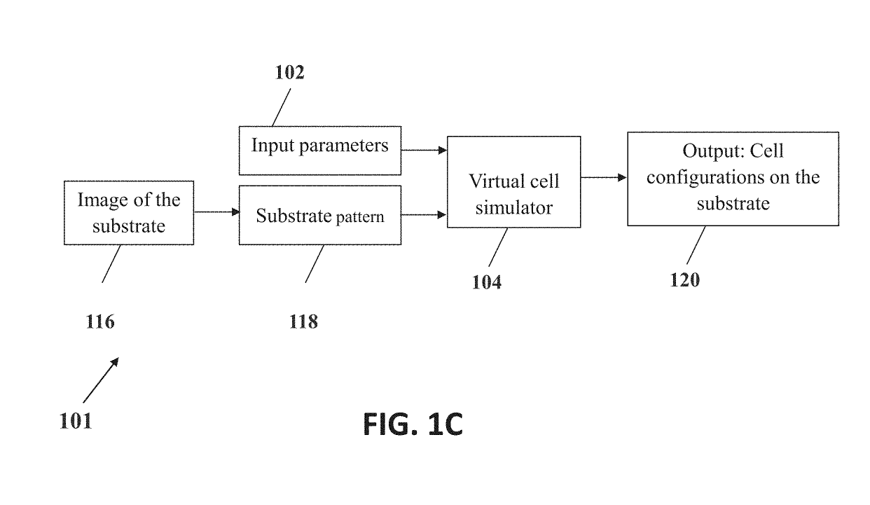

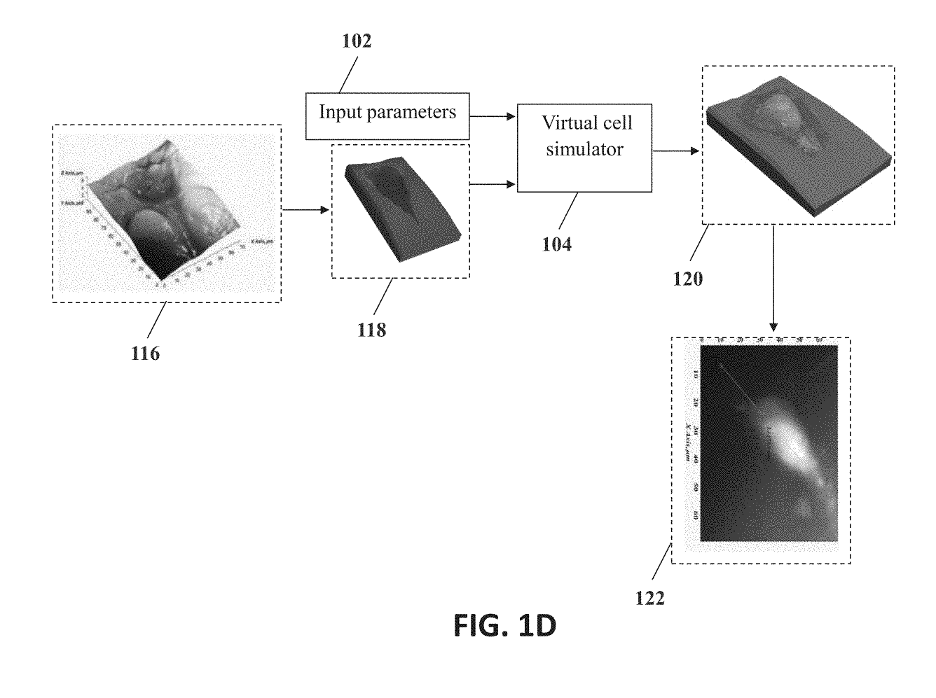

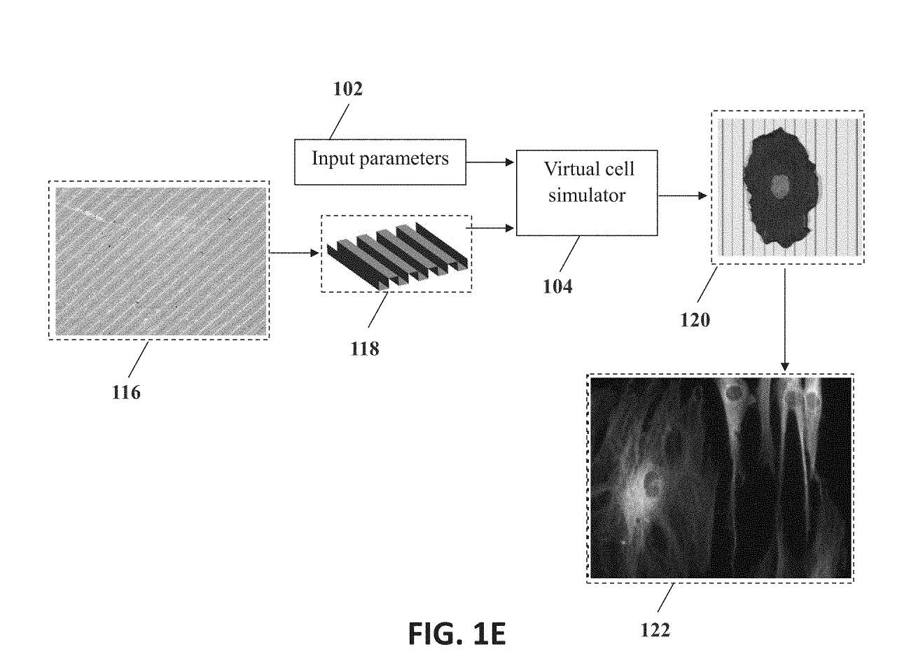

As an introduction to one implementation of the virtual cell model, FIG. 1A presents a flow chart providing an overview of a first virtual cell simulating system (“first system”) 100 and a method for using the first system 100. In different implementations, the first system 100 can be configured to simulate a living cell, and/or to study cells with different properties. For example, in some implementations, cell input parameters (“input parameters”) 102 may be entered via an input file. This may occur as a result of manual user input, or can be entered via an automated method or system. A virtual cell model 106 is then generated or otherwise prepared by a virtual cell simulator 104. In some implementations, the virtual cell model 106 may include a 3D cell model configured to simulate and/or investigate a cell's behavior in a 3D environment. In different implementations, the cell input parameters 102 may include geometrical properties of the cell and nucleus membranes, viscoelasticity of the cytoskeleton, and/or the number and length of chromatin fibers inside the nucleus, as well as other cell and substrate characteristics.

For purposes of clarity, an image of one implementation of the simulated virtual cell model 106 is presented in FIG. 1B. The cell membrane and the cytoskeleton network are transparent to reveal the inner structure of the virtual model to the reader. In FIG. 1B, the virtual cell model 106 includes at least a cell membrane 108, which may also be referred to as an “outer cell membrane” or an “outer membrane”, a nucleus membrane 112, a cytoskeleton network 110, and chromatin fiber(s) 114, represented by portions in a white color within the nucleus membrane.

Referring now to FIG. 1C, a flow chart providing an overview of a second virtual cell simulating system (“second system”) 101 and a method for using the second system 101 are presented. In some implementations, the second system 101 may be configured to simulate the behavior of a living cell during interaction(s) with a substrate. In FIG. 1C it can be seen the second system 101 and/or its corresponding method can be configured to incorporate or receive the cell input parameters 102 as well as a substrate pattern 118. These data can be entered into the virtual cell simulator 104. In some implementations, the substrate pattern 118 may be obtained from a 3D image scan of the actual substrate, here as micro-patterns (“image of the substrate”) 116, and/or data from other tests. In some implementations, an output 120 of the second system 101 may include the configurations of the cell and substrate throughout the simulation and/or experimental parameters of interest to the user such as the system energy, peaks and lows, significant statistical values, and other such data.

In FIGS. 1D and 1E, two additional examples of the overall input and output of the second system 101 are shown, as well as a comparison between the output 120 of the virtual cell simulator 104 and a corresponding experimental result 122. It should be noted that the substrate pattern 118 that is inputted into the simulation may be obtained directly from experimental micro-patterns 116 via commercially available software, though in other implementations the patterns can be obtained or developed by a user and/or otherwise customized. As shown in FIGS. 1D and 1E, the output 120 is well supported by the experimental result 122.

### A. Theoretical Background

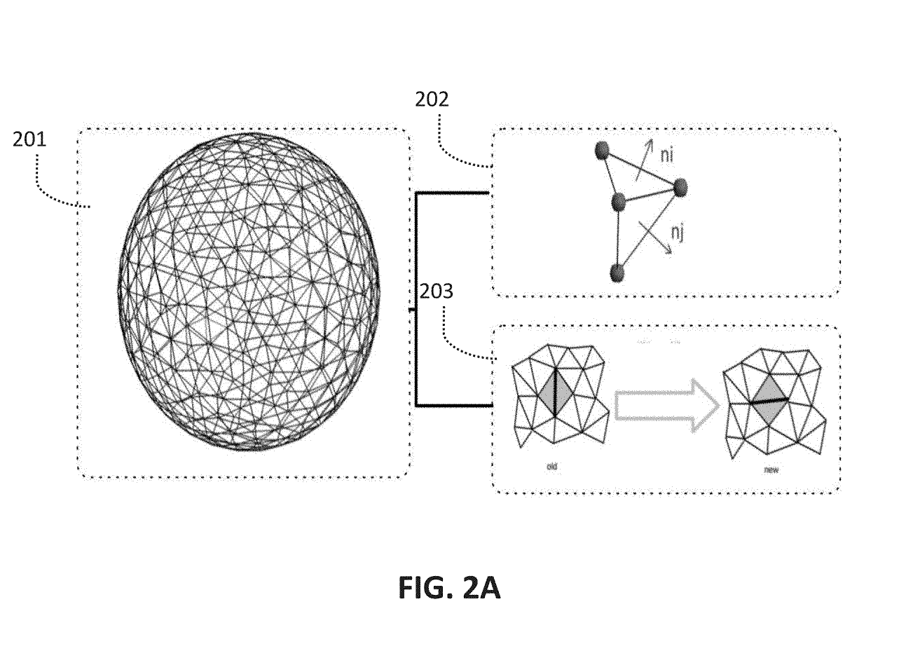

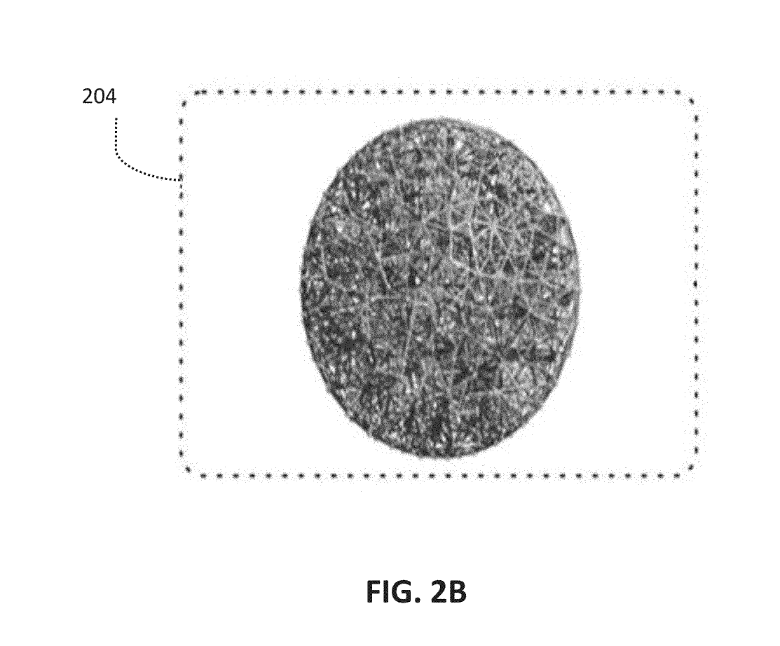

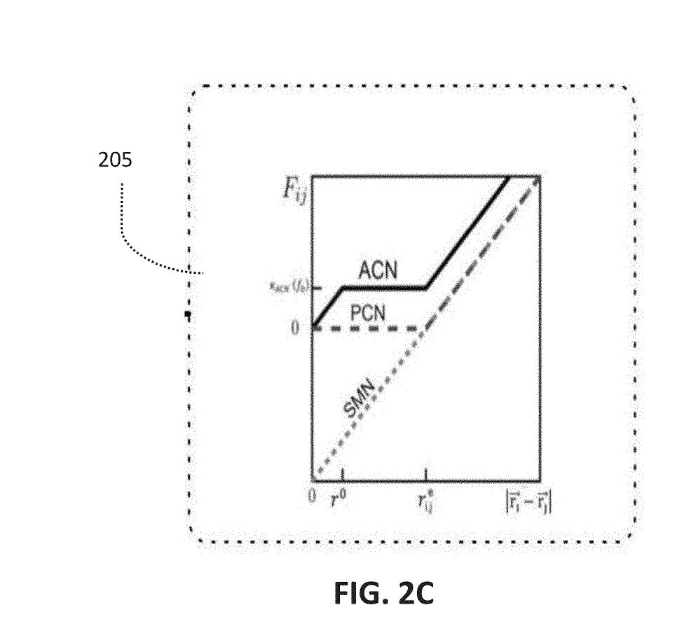

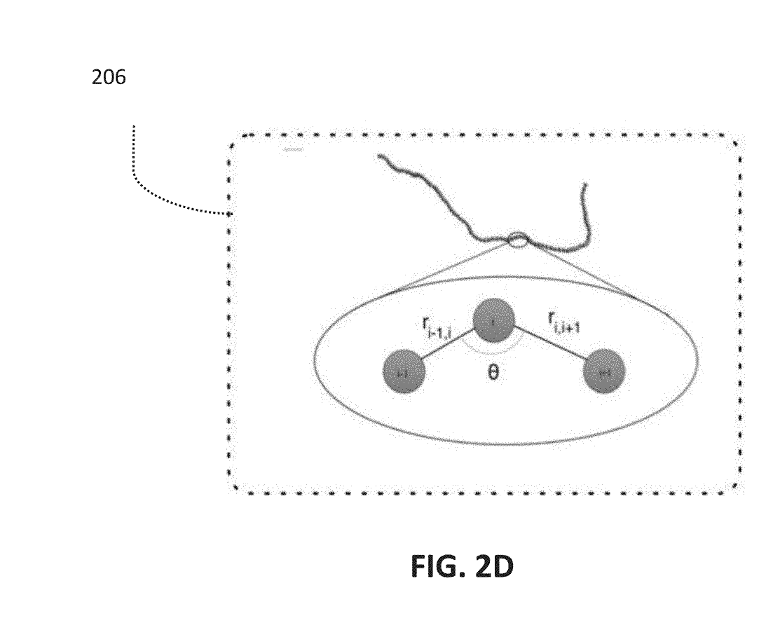

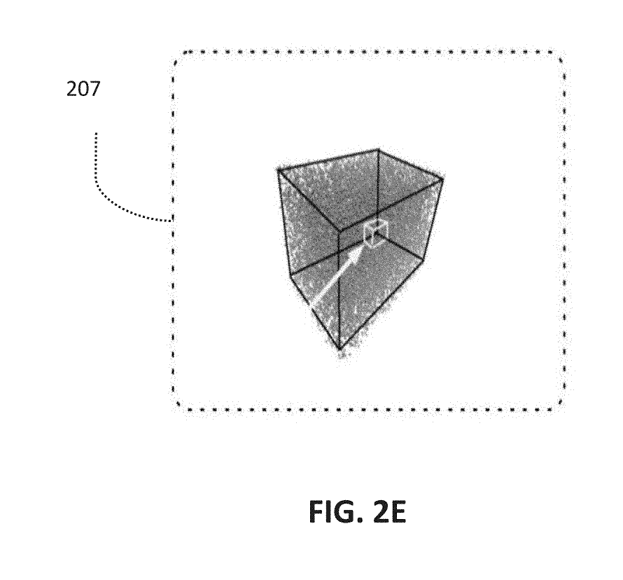

In different implementations, the virtual cell model will consist of a cell membrane, cytoskeleton, nucleus membrane, as well as chromatin fibers which are confined inside the nucleus. Each portion or section of the virtual cell can be simulated through a self-consisting physical model configured to represent a corresponding ‘real’ cell section in both dimension and time scales. FIGS. 2A-2E show different sections of an implementation of a virtual cell model.

Referring first to FIG. 2A, it can be understood that the cell and nucleus membranes 201 are modeled by a triangulated membrane model. This model has been shown to accurately capture the physical characteristics of a lipid membrane, particularly the mechanical properties and membrane fluidity, across large length scales (up to several micrometers) with low computational cost. The Hamiltonian of a triangulated surface is given by Eq. (1) below:

$${U}_{membrane} = {U}_{bonding} + {U}_{repulsion} + {U}_{curvature} + {U}_{surfacearea} + {U}_{volume} = b {\sum }_{< {i}^{v} , {j}^{v} >} \frac{exp ( \frac{1}{{l}_{c 0} - {r}_{i , j}} )}{{l}_{max} - {r}_{i , j}} + b {\sum }_{< {i}^{v} , {j}^{v} >} \frac{exp ( \frac{1}{{r}_{i , j} - {l}_{c 1}} )}{{r}_{i , j} - {l}_{min}} + \frac{{κ}_{curve}}{2} {\sum }_{< {i}^{v} , {j}^{e} >} ( 1 - cos {θ}_{i , j} ) + \frac{{κ}_{s}}{2} {( S - {S}_{0} )}^{2} + \frac{{κ}_{v}}{2} {( V - {V}_{0} )}^{2} . \qquad Eq . ( 1 )$$

With respect to Eq. (1), the terms U_{bonding} and Uᵣₑₚᵤₗₛᵢₒₙ refer to the bonding and repulsive potentials which limit the bond length in the range of [1ₘᵢₙ,1ₘₐₓ]. Here r_{i,j} is the distance between neighboring vertices, and the first and the second sums are across all connected vertices. In addition, U_{curvature} is the curvature energy, θ_{i,j} is the angle between two normal vectors of neighboring elements (see FIG. 2A, part 202), and the sum is across all neighboring triangles. The surface area of membranes is maintained at a substantially constant value during the simulations by application of an energy constraint on surface area U_{surfacearea}. Imposing a volume constraint on the cell or nucleus is also possible via the potential Uᵥₒₗᵤₘₑ. The values of the coefficients are set to:

b=80K_{B}T,lₘₐₓ=1.33a,lₘᵢₙ=0.67a,l_{c0}=1.15a,l_{c1}=0.85a,κ_{curve}=20K_{B}T,κₛ=1

where a=1 μm is the average bond length. One advantage of this model is that the fluidity of the lipid membrane is taken into account by the bond flipping between two neighboring triangles (see FIG. 2A, part 203) with the probability of:

$${P}_{old -> new} = {e}^{- \frac{{U}_{new} - {U}_{old}}{{K}_{B} T}} \qquad Eq . ( 2 )$$

The number of bonds that are chosen to flip at the same time in this model is set to ensure that the membranes are in viscous regime. As noted above, both the cell and nucleus membranes are modeled by triangulated membrane. However, the radius of cell is larger than nucleus.

In addition, the cytoskeleton of the cell, another essential component of ‘real’ cells, is modeled as a physical network with various active and/or passive properties (see FIG. 2B, part 204). This network includes distributed mass particles (nodes) distributed or disposed between the cell and nucleus membranes that are connected to each other. For purposes of the virtual cell model, for a single linkage (bond) between two cytoskeleton nodes i and j, if the cytoskeleton network follows the simple Maxwellian visco-elastic network (SMN), the force generated by the linkage is given by:

\vec{f}_{i,j}=κSMN(|\vec{r}ⱼ−\vec{r}ⱼ|−|\vec{r}_{i,j}^{e}|)ê Eq. (3)

This is also represented in FIG. 2C, part 205. In Eq. (3) above, the value \vec{r_{i,j}^{e}}, refers to the equilibrium length of the linkage, whose dynamics is given by:

$$\frac{{dr}_{i , j}^{e}}{dt} = \frac{{f}_{i , j}}{{μ}_{SMN}} . \qquad Eq . ( 4 )$$

where κ_{SMN} is the linkage stiffness and μ_{ECM} is viscosity.

Furthermore, in cases where the network follows a passive cable network (PCN), the force generated by the linkage is:

\vec{f}_{i,j}=κ_{PCN}(|\vec{r}ⱼ−\vec{r}ⱼ|−|\vec{r}_{i,j}^{e}|)ê, if |\vec{rᵢ}−\vec{rⱼ}|>|\vec{r_{i,j}^{e}}| Eq. (5)

\vec{f}_{i,j}=0, if |\vec{rᵢ}−\vec{rⱼ}|<|\vec{r_{i,j}^{e}}| Eq. (6)

In addition, in the case of active cable network (ACN), the force generated by the linkage is:

\vec{f}_{i,j}=κ_{ACN}(|\vec{r}ⱼ−\vec{r}ⱼ|−\vec{r}_{i,j}^{e}|+l₀)ê, if |\vec{r}ᵢ−\vec{r}ⱼ|>|\vec{r_{i,j}^{e}}| Eq. (7)

\vec{f}_{i,j}=κ_{ACN}(l₀)ê, if r⁰<|\vec{rᵢ}−\vec{rⱼ}|<|\vec{r_{i,j}^{e}}| Eq. (8)

\vec{f}_{i,j}=κ_{ACN}|\vec{r}_{i,j}^{e}|(|\vec{r}ⱼ−\vec{r}ⱼ|/l₀)ê, if |\vec{rᵢ}−\vec{rⱼ}|<r⁰ Eq. (9)

where l₀ and r⁰ are the model parameters. The equilibrium lengths in PCN and ACN are static.

Furthermore, as noted above, chromatin fibers are located within the nucleus membrane. In order to model the chromatin fibers over large length scales, the coarse-grained model of beads and springs is applied. In this model, the values for the characteristics of chromatin fibers, including but not limited to length, radius and rigidity of the fibers, are set by reference to experimentally measured mechanical properties of the chromatin fibers. The Hamiltonian of chromatin fibers is represented by:

$${U}_{ chains} = {U}_{bond} + {U}_{bending} + {U}_{excludedvuolume} = \frac{{κ}_{bonding}}{2} {\sum }_{i = 1}^{{N}_{c}} {\sum }_{j = 1}^{{N}_{i} - 1} {( {r}_{j , j + 1}^{i} - 2 σ )}^{2} + \frac{{κ}_{bending}}{2} {\sum }_{i = 1}^{{N}_{c}} {\sum }_{j = 1}^{{N}_{i} - 2} {( {θ}_{j , j + 1}^{i} - {θ}_{0} )}^{2} + {\sum }_{{< i , j >}_{i \neq j , i < j , {r}_{i , j} < 1.12 σ}} 4 ∈ \{ {( \frac{σ}{{r}_{i , j}} )}^{12} - {( \frac{σ}{{r}_{i , j}} )}^{6} \} . \qquad Eq . ( 10 )$$

In Eq. (10), Nᵢ refers to the number of beads in the i^{th} chromatin chain, κ_{bond} is connectivity stiffness, and κ_{bending} is the bending stiffness in the chromatin fibers. In addition, the size of each bead is given by σr_{M+1}ⁱ is the length of the bond between the i^{th} and j^{th} chromatin beads, and θ_{i,j+1}^{j} is the angle between two neighboring bonds (see FIG. 2D, part 206). The excluded volume interaction between each pair along the fibers is simulated by the repulsive component of the Lennard-Jonse potential.

In different implementations, the cell may be situated or disposed on and/or in a virtual extracellular matrix (ECM) that is associated with different mechanical characteristics and shapes. In some cases, the ECM architecture can be understood to be configured in a manner similar to that of the cytoskeleton network: connected mass particles with bonds, as well as a triangulated surface that cell membrane could interact with. In addition, the type of the bonds is SMN, and so the force of a linkage of ECM between i^{th} and j^{th} nodes is calculated using:

$$\begin{matrix}{\vec{f}}_{i , j} = {κ}_{ECM} ( \vert {\vec{r}}_{j} - {\vec{r}}_{j} \vert - \vert {\vec{r}}_{i , j}^{e} \vert ) \hat{e} , & Eq . ( 11 ) \\ \frac{{dr}_{i , j}^{o}}{dt} = \frac{{f}_{i , j}}{{μ}_{ECM}} & Eq . ( 12 )\end{matrix}$$

where κ_{ECM} is bond stiffness and μ_{ECM} is viscosity, and the remaining definitions are the same as SMN part of cytoskeleton network.

Furthermore, for purposes of this example, the interaction between the cell and the ECM occurs as the membrane elements are close enough to the ECM surface elements. They then interact with the (10-4) Lennard-Jones potential:

$${u}_{L - J}^{i , j} = 4 {∈}_{sub} \{ {( \frac{{σ}_{⊥}}{{d}_{⊥}^{i , j}} )}^{10} - {( \frac{{σ}_{⊥}}{{d}_{⊥}^{i , j}} )}^{4} \} \qquad Eq . ( 13 )$$

where d_{⊥}^{i,j} is the orthogonal distance between the membrane and substrate elements, σ_{⊥} controls the range of interaction, and ∈_{sub} controls the strength of interaction.

In addition, an active stretching force is added to the cell boundary to model the actin polymerization force in cell edges. To study a migrating cell, migration parameters such as initial direction, total tracking force, the type of distributing of tracking forces, and other such parameters, are also considered in the virtual cell model.

Furthermore, in some implementations, an explicit solvent model (MPCD) is also implemented in the software in order to incorporate aquatic media that can be characterized by different types of fluid flows. In this model, the simulation box is discretized into cubic lattices, and the (virtual) solvent particles are arranged such that they stream freely inside and between lattice grids in the streaming step (see FIG. 2E, part 207). The velocity of the solvent particles is updated locally in each lattice during the collision step. In addition, in the collision step, the system particles (solvent particles, membrane nodes, and chromatin beads) are sorted into lattices. The particle velocities \vec{v}_{oid}^{p} that share a lattice are updated as follows:

\vec{v}_{new}^{p}=\vec{v}_{com}^{lattice}+Ω(\vec{v}_{new}^{p}−\vec{v}_{com}^{lattice}), Eq. (14)

where \vec{v}_{com}^{lattice} is the velocity of the center of mass of all particles present in the corresponding lattice and Ω is the operator which rotates a vector by the angle of

$$\frac{π}{2}$$

round a randomly chosen unit vector. Collision steps take place once in every 25 MD steps (molecular dynamics steps). In different implementations, each or all of these parts are integrated together to provide a 3D cell model consistent with the mechanics of an actual cell.

### B. Overview of the Software Architecture

In different implementations, the virtual cell model can be provided through computer software. Thus, the virtual cell model can be easily accessible in standard computer interface. In some implementations, users can select the interface by which the virtual cell model will be manipulated or observed, such as a desktop, laptop, tablet, or other digital computing device. Referring back to FIGS. 1D and 1E, two examples of the overall input and output of the software were presented, as well as a comparison between the software result or output 120 and the experimental result 122. It can be understood that in this case the substrate patterns 118 with which the simulation is performed in this example were obtained directly from the experimental micro-patterns 116 via software available in the market.

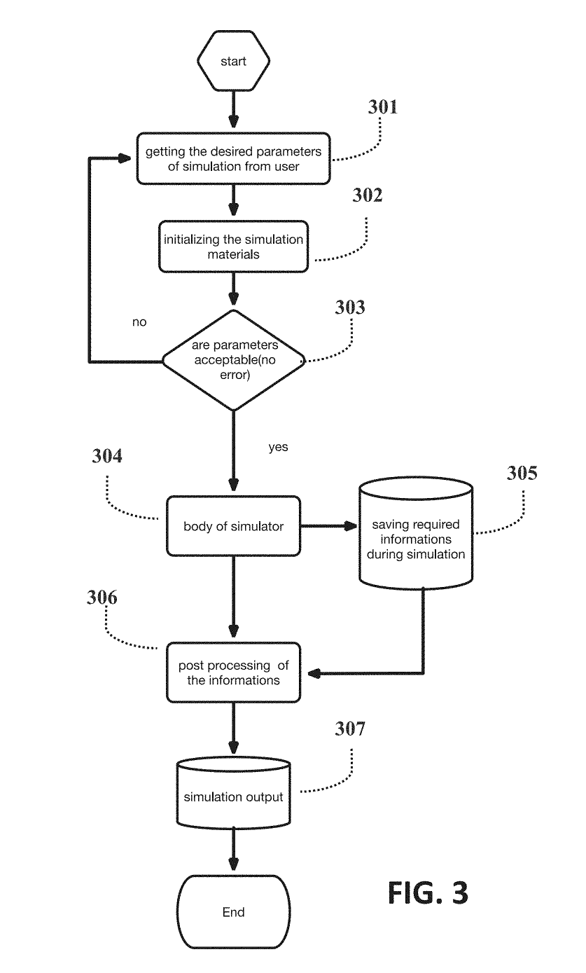

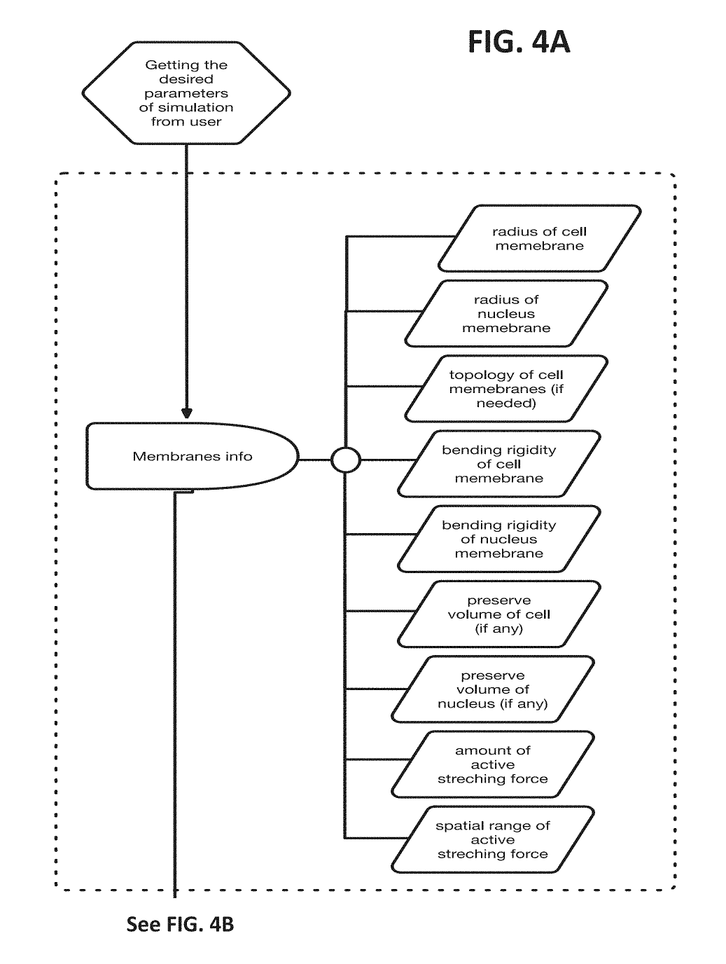

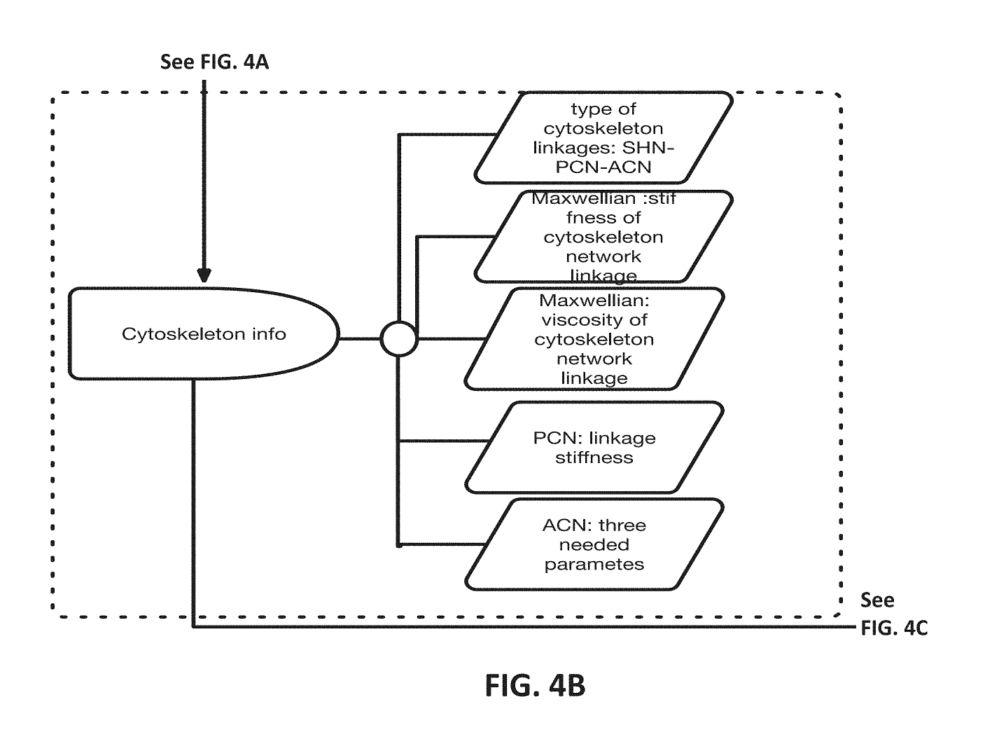

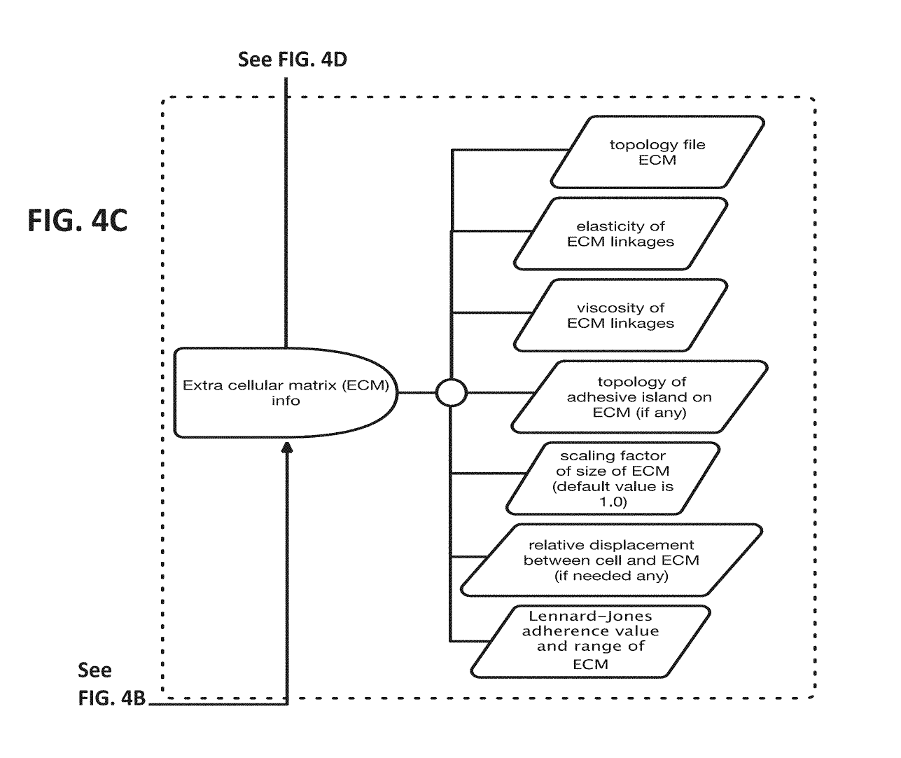

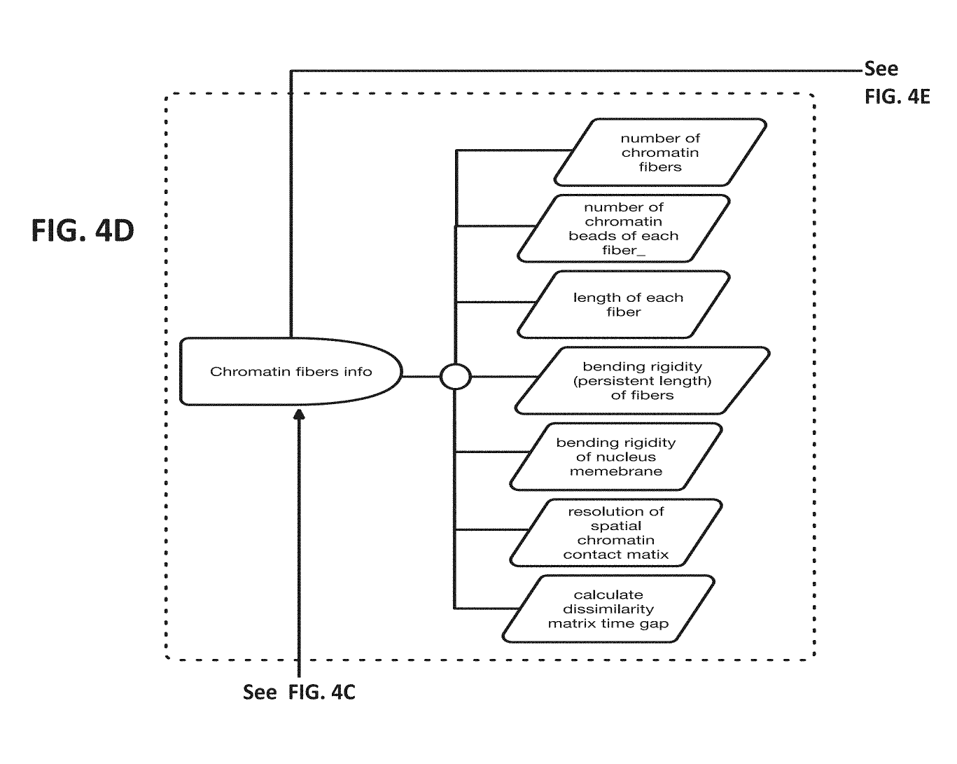

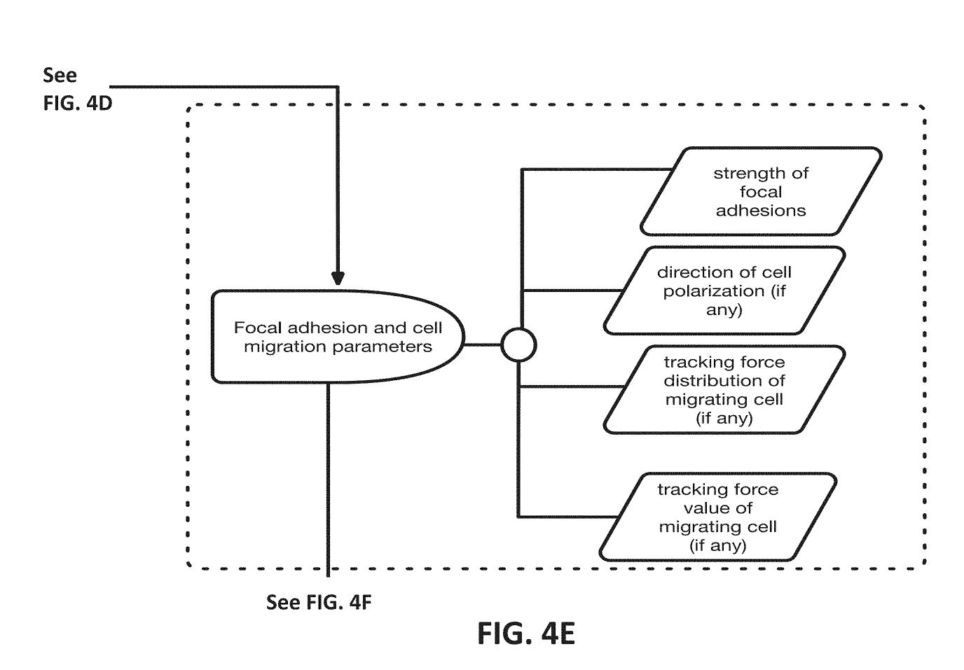

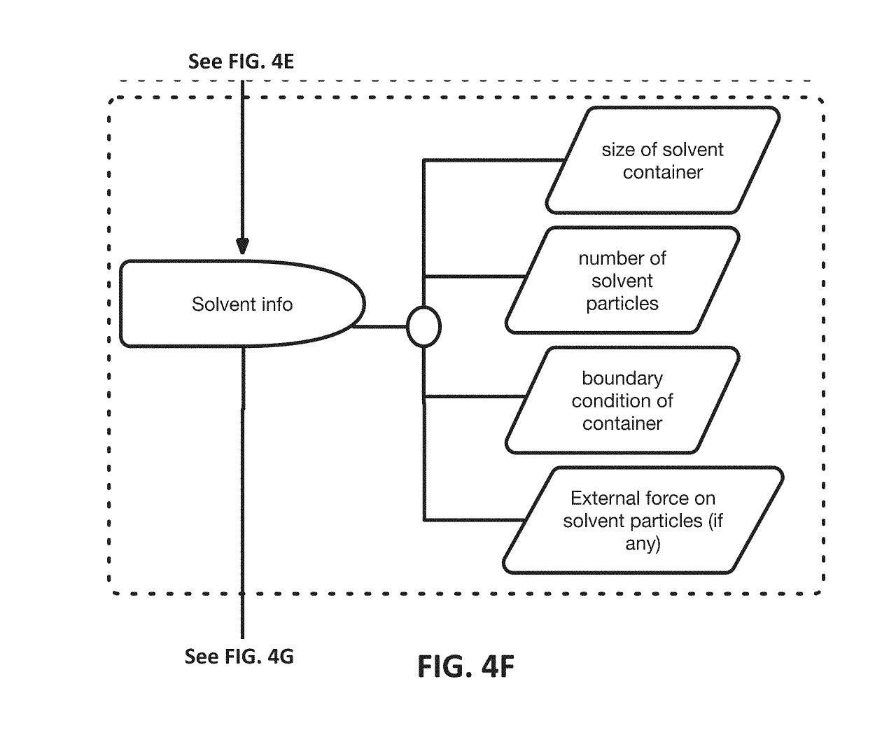

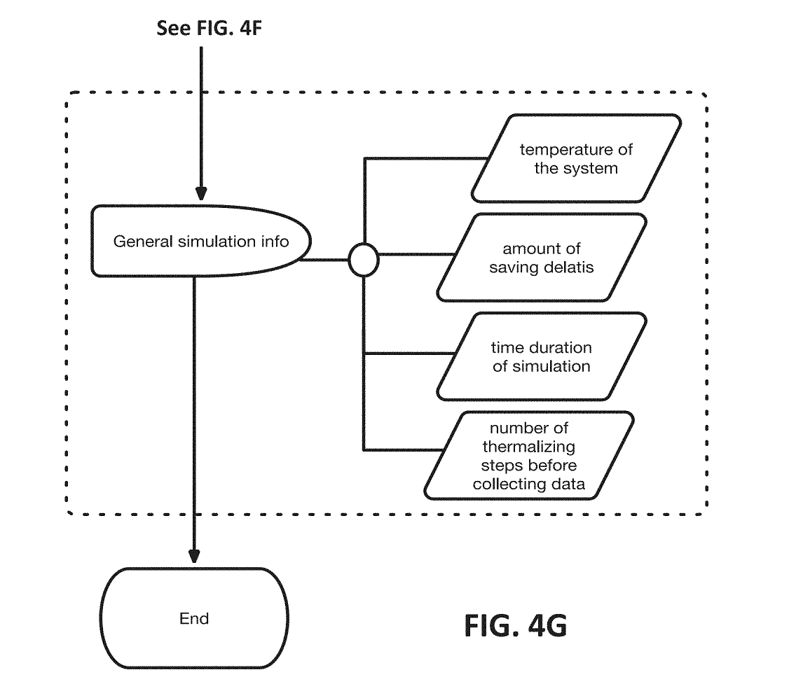

In different implementations, the modeling software is configured to operate as a fine-tuned, step by step process, until reaching and generating the final simulation outputs. In some implementations, this process consists of several simulation blocks, an example of which is presented in FIG. 3. In FIG. 3, a flow diagram of an implementation of an overview of the integrated structure of the software, from start to end, is illustrated. A first block 301 of the simulation includes obtaining and reading the input files/parameters from the user for the desired simulation. This permits the user to have access to the variety of simulation resources and flexible material characteristics. Further details regarding the first block 301 will be provided with respect to FIGS. 4A-4G.

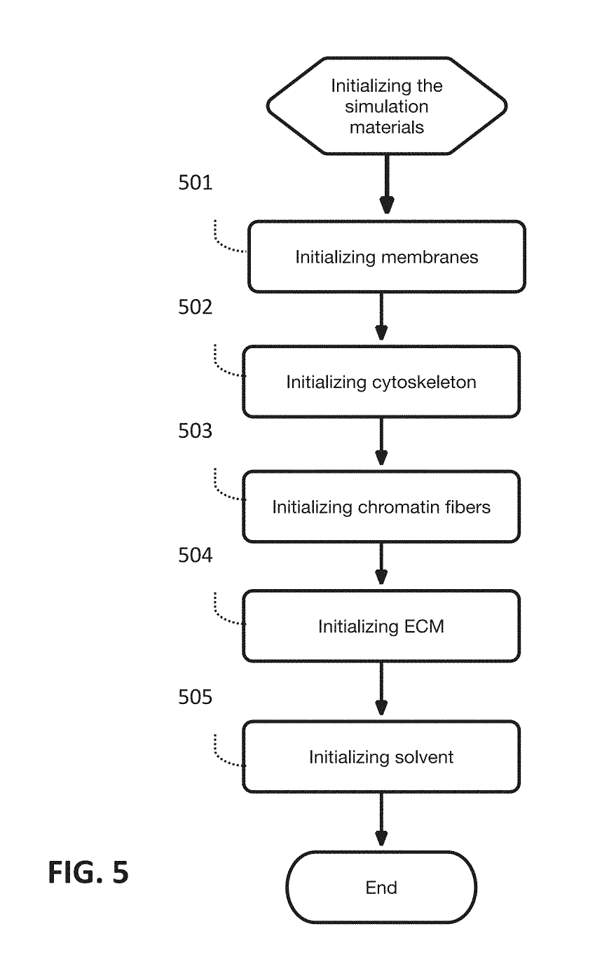

After importing a user's inputs, a next step may include generating or initializing data with suitable initial values, which is assigned or entered directly by the user and/or extrapolated from the processed information, as indicated by a second block 302. Further details regarding the second block 302 will be provided with respect to FIG. 5. In order to ensure accuracy and/or consistency of any imported input files/parameters by the user, the inputted data will be checked, as represented by a third block 303, and if all data are consistent and acceptable, the body of the virtual cell simulator will initiate or perform the simulation, as indicated by a fourth block 304. In different implementations, the fourth block 304 includes several subroutines which are run or performed during each of a series or sequence of time steps of the simulation. Furthermore, during each time step of the simulation, the required information is saved by the system, as indicated by a fifth block 305. When the simulation is complete, the software is configured to post-process the stored information, as indicated in a sixth block 306. The post-processing leads to the final outputs and results of the simulation. These results will be saved in an output file, as indicated by a seventh block 307.

### C. Details Regarding the Software Architecture

In different implementations, during initial use of the virtual cell model, the simulator may first be loaded with a configuration, as well as the setup of the virtual experiment. This step can involve a user entering or otherwise providing the system with the characteristics of the cell and the substratum with which the cell interacts. FIGS. 4A-4G present one implementation of this process. As shown in FIG. 4A, a first step can involve obtaining parameters of the cell and nucleus membranes. For example, in some implementations, these parameters include the radius of the cell, the radius of the nucleus membrane, the bending rigidity of the lipid membrane of cell, and the bending rigidity of the nucleus, and other such parameters. These parameters can vary widely based on the type of the cell to be modeled. In some cases, the user might refer to established or previously listed cell properties for parameters, such as standard biophysical facts. For example, the volume of the cell or the volume of a nucleus may have a fixed volume depending on the cell type. The first step can also involve setting the value of the effective forces produced by actin polymerization in cell edges. However, the system may also include a selection of initial or default values for a typical cell that may be used if the user chooses not to input other values.

As illustrated in FIG. 4B, a second step can include the entry or input of values associated with the parameters of the cytoskeleton. In the implementation of FIG. 4B, three different types of cytoskeleton can be assigned to the software, including the simple viscoelastic model, the passive cable network model, and the active cable network model. The topological architecture of the cytoskeleton can be set by the cell and nucleus radii. In different implementations, the user can choose the type of the network, and then import the mechanical parameters of the model. In this implementation, the default type is a viscoelastic model with initial mechanical values of a typical cell.

In some implementations, the configuration of the extra cellular matrix (ECM) or substratum can be directly imported by the user in a topology file format in a third step shown in FIG. 4C, after which the elasticity and viscosity of the ECM is imported to the software. In some cases where the substratum has adhesive islands which only cell could bind focal adhesion on it, these islands can be imported in separate configuration file. In addition, the size of the ECM can be scaled according to a length scale tuning of the ECM.

In a fourth step represented in FIG. 4D, the values of the parameters of the chromatin fibers inside the nucleus from the user are entered. The bending rigidity of fibers is also adjustable or customizable during this step, as well as the resolution of the outputs. In some implementations, the strength of the focal adhesion bonds between the substratum and the cell cytoskeleton can be adjusted in an optional fifth step (see FIG. 4E). In cases where the model includes a migrating cell, the corresponding parameters can be imported during the fifth step as well.

Furthermore, in some implementations, the cell to be modeled could be placed in a mesoscopic solvent which resembles aquatic media. The simulation box can include a plurality of solvents and/or the boundary conditions of the solvent container. Such parameters can be entered during a sixth step, as seen in FIG. 4F. The system temperature can be assigned in a seventh step (see FIG. 4G).

An overview of an implementation of the initialization of the simulation materials, allocation of the corresponding memory, and assignment of the values of the system parameters (as discussed with respect to FIGS. 4A-4G) at t=0 is depicted in the block of FIG. 5. For example, simulation materials of the membrane 501, cytoskeleton 502, chromatin fibers 503, extra-cellular matrix 504, and the solvent 505 are implemented in this block. Further details regarding the initialization steps are provided below.

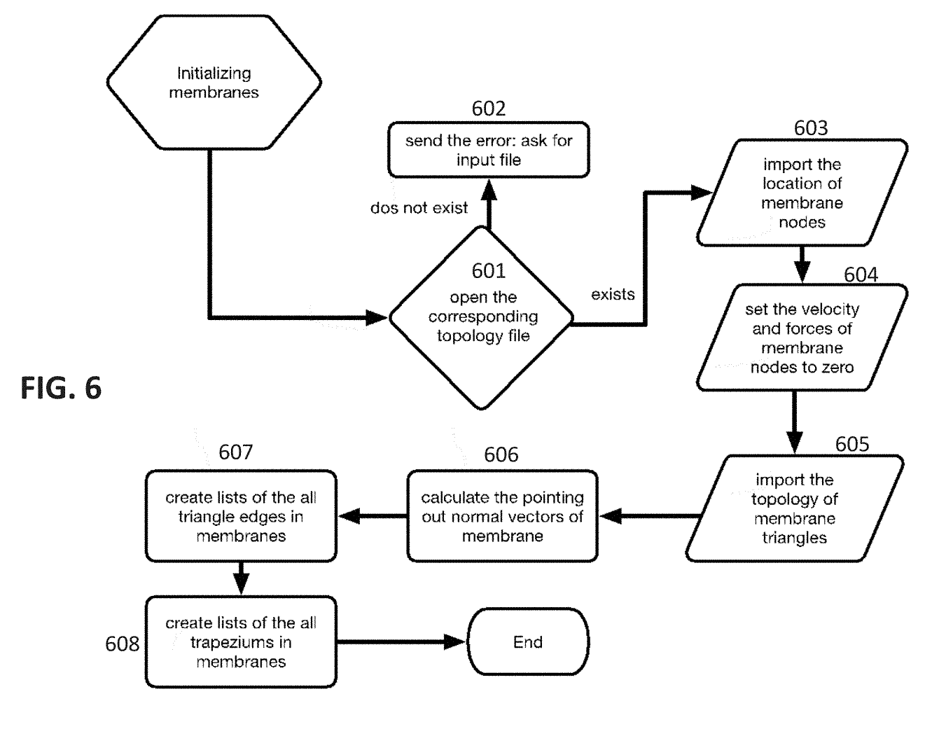

As shown in FIG. 6, in different implementations, initializing the membrane (see 501 in FIGS. 5 and 6), can begin with opening the topology file in a first step 601. In some cases, the software can perform a search for a membrane topology file, which includes information representing the cell with an appropriate outer radius and nucleus radius. If the topology file is not present in the specified directory, an error may be generated in a second step 602. After opening the topology file, memory can be allocated to the membrane node position vectors and assigned coordinates from the topology file in a third step 603. In a fourth step 604, with respect to the size of the membranes, the vectors of the velocities and forces can be generated with initial values of zero. Because the membrane consists of nodes with a triangular surface topology, the topology of these triangles can be imported into a separate memory in a fifth step 605. In some implementations, to facilitate a reduction in computational costs during the simulation, the lists of all outward pointing surface vectors can be initialized into the computer memory in a sixth step 606, edges of triangles can be distinguished and initialized into the computer memory in a seventh step 607, and/or all possible trapeziums which consist of two neighboring triangles can be initialized into the computer memory in an eighth step 608.

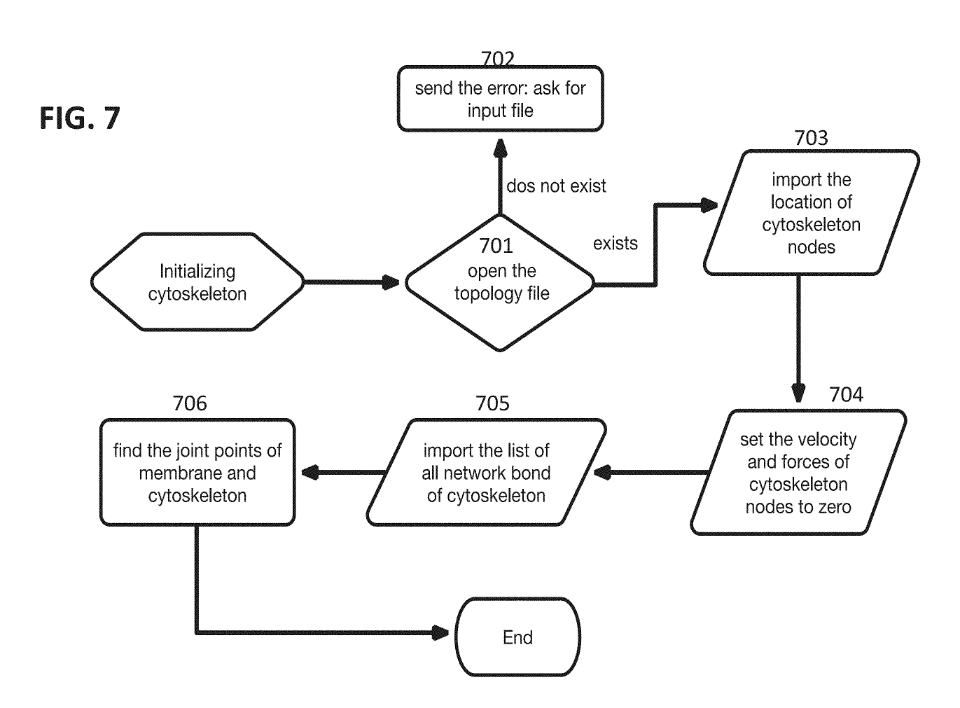

In different implementations, the initialization of the cytoskeleton can occur in a manner analogous to the membrane initialization described above with respect to FIG. 6. Referring to the implementation of FIG. 7, the initialization of the cytoskeleton (see 502 in FIGS. 5 and 7) can begin with the opening of the topology file in a first step 701. For example, the software can perform a search for the cytoskeleton topology file which includes information representing the cell with appropriate outer radius and nucleus radius. If the topology file is not present in a suitable directory, an input error can be generated in a second step 702. In some implementations, allocating memory for the cytoskeleton position vectors and assigning initial values from the topology file for these vectors can be accomplished via the routine depicted in a third step 703 of FIG. 7.

In a fourth step 704, the information representing the cytoskeleton nodes can be initialized, in a manner similar to that of the fourth step 604 of FIG. 6. The cytoskeleton can be understood to comprise a connected network of beads. Thus, storing information regarding the edges (or bonds) of this network is an important step, indicated by a fifth step 705. The cytoskeleton network meets the membrane nodes along the nucleus and cell surfaces in regions referred to as joint points. The joint points are responsible for transferring forces between the cell membrane, cytoskeleton, and nucleus membrane. A list of joint points is generated and saved to into computer memory during a sixth step 706.

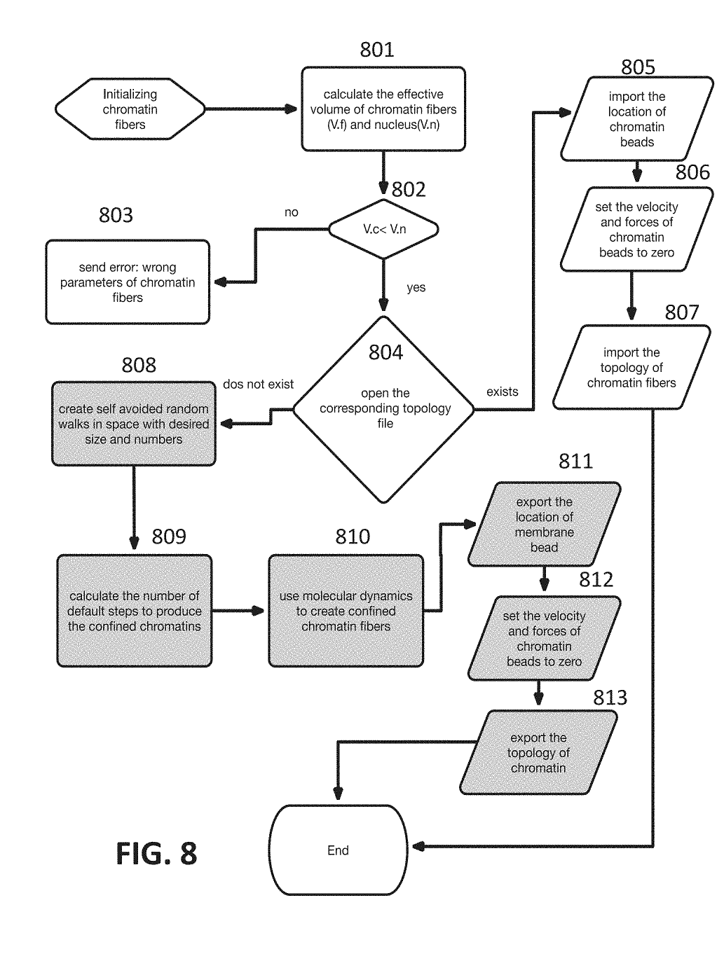

After initialization of the computational materials for the membrane and cytoskeleton as described above, the software will initialize the information for the chromatin fibers (see 503 in FIGS. 5 and 8). In some implementations, prior to allocation of memory to the chromatin variables, the software calculates the total volume of chromatin fibers (V_{f}) and the volume of the nucleus (Vₙ) in a first step 801. There is an assessment in which the system ascertains whether V_{f}<Vₙ or not, during a second step 802. This condition should be satisfied since the chromatin fibers are located inside the nucleus. If V_{f}>Vₙ, an error is generated in a third step 803. However, if V_{f}<Vₙ, the system can open the corresponding topology file for the chromatin fibers in a fourth step 804. If the appropriate input file exists, similar to the third step 603 and the fourth step 604 of FIG. 6, the system will initialize the position, velocity and force vectors of chromatin beads in a fifth step 805 and a sixth step 806, and the connectivity of the chromatin beads to each other is initialized to the software in a seventh step 807. In contrast to the first step 601 of FIG. 6 and the first step 701 of FIG. 7, in some implementations, if the appropriate input file does not already exist, the software can be configured to generate information for confined chromatin fibers with a molecular dynamics (MD) process. An eighth step 808 creates a self-avoided random walk in 3D space. In this case, the step size of the random walk represents the bead size of the chromatin fibers. Thus, the number of steps is equal to the total number of chromatin beads. With respect to the effective radius of the nucleus (which is smaller than a real radius of nucleus because of the effective thickness of the nucleus membrane for the chromatin fibers) and the produced size of the random walk, the required number of MD steps for confining the chromatin fibers is calculated in a ninth step 809. A tenth step 810 is directed to the body of MD process, which confines the chromatin fibers in a spherical volume, where the radius is equal to the radius of the nucleus. Additional steps (an eleventh step 811, twelfth step 812, and thirteenth step 813) involve exporting the results of the tenth step 810 to the software, in a process similar to fifth step 805, sixth step 806, and seventh step 807 describe with respect to FIG. 8.

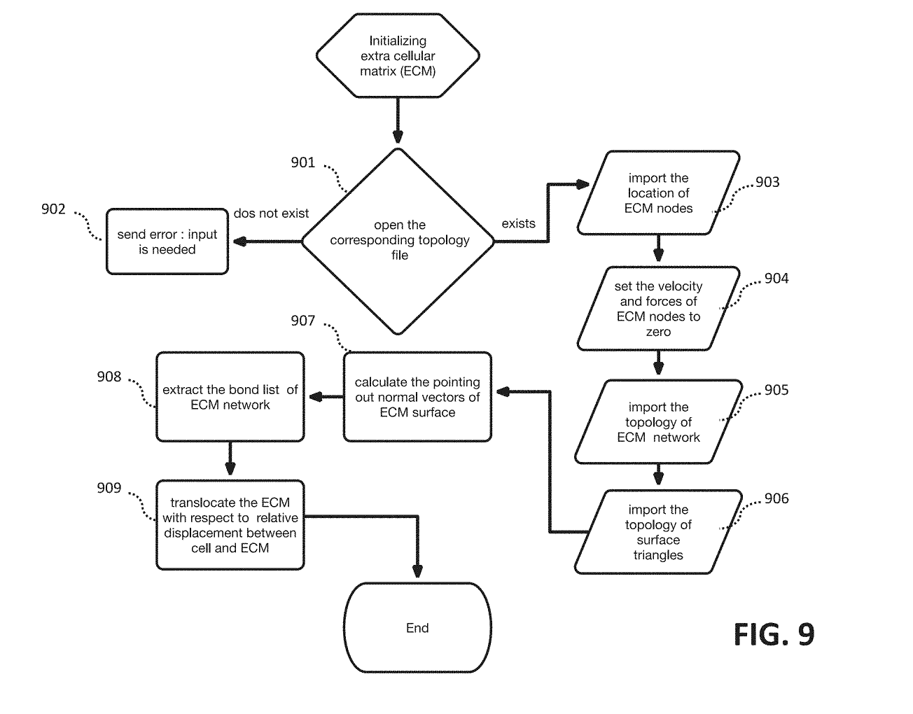

Furthermore, referring to FIG. 9, initializing the ECM (introduced as fifth step 504 in FIG. 5) can begin with opening the topology file with a mesh format in a first step 901. The software first performs a search for the ECM topology. If the topology file does not exist, an error is generated in a second step 902 and the process is terminated. The ECM consists of mass particles (nodes) which are connected to each other through a visco-elastic network. Some of these nodes form a triangular surface, which the cell interacts with them. A third step 903 allocates memory to the ECM node position vectors and assigns initial values from the topology file to the vectors. A fourth step 904 and a fifth step 905 follow, performing substantially similar functions as fourth step 604 and fifth step 605 in FIG. 6 above, with respect to ECM nodes. The topology of triangulated surface is then captured from the topology file in a sixth step 906. Furthermore, a seventh step 907 and an eighth step 908 can be understood to perform the same tasks for ECM surface triangles as the sixth step 606 and seventh step 607 in FIG. 6. As noted above, the relative position of cell with respect to the ECM is adjustable (see the third step 403 of FIG. 4); this displacement is implemented in a ninth step 909 in FIG. 9.

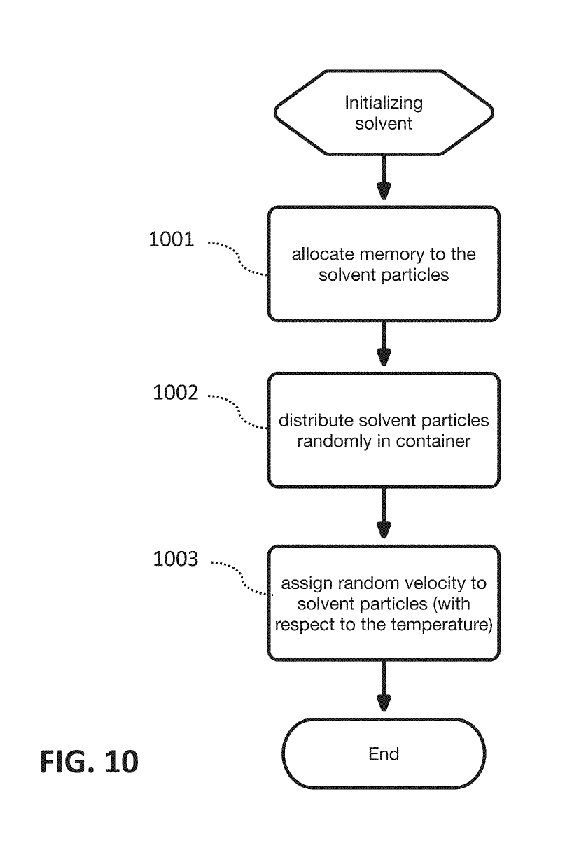

Referring next to FIG. 10, in different implementations, the cell body could be immersed in a mesoscopic solvent which is simulated by Multi Particle Collision Dynamics. The boundaries of the solvent are specified by a simulation box, which is implemented by a first step 1001 in FIG. 10. The solvent particles are placed into this box. It may be understood that there may be hundreds of thousands of solvent particles, which at the beginning of the simulation at t=0 are distributed randomly and uniformly inside the simulation box during a second step 1002. The particles are also assigned a random velocity distribution to generate the desired temperature, which is implemented in a third step 1003.

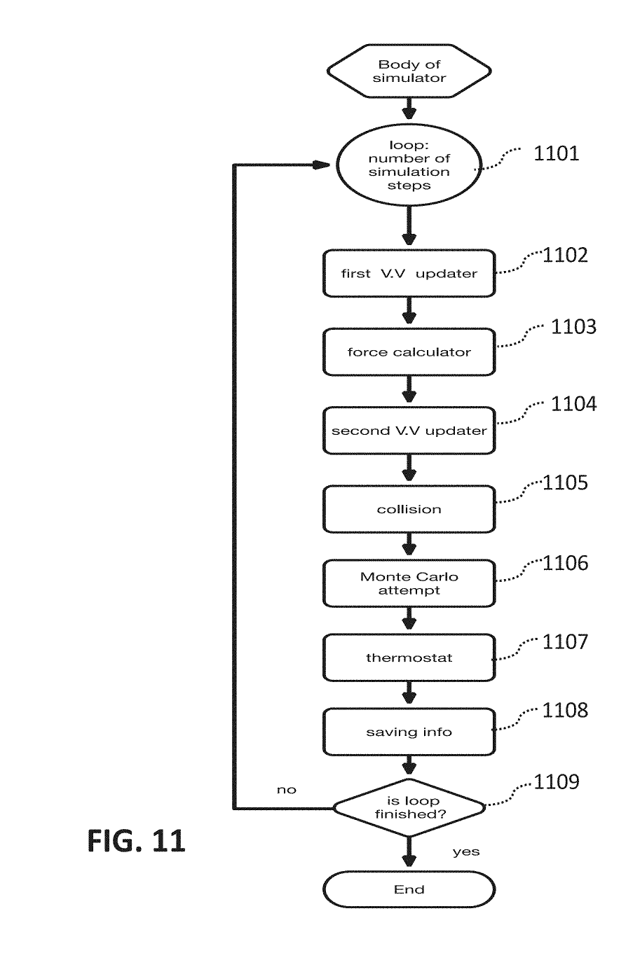

After initializing the simulation materials, if no error is generated (see, for example, the third step 303 of FIG. 3), the software starts the body of the simulator (see fourth step 304 in FIG. 3). Referring to FIG. 11, the body of the simulator consists of a loop of time steps that bring the system from t=0 into t=T_{final}. This occurs by integrating the equations of motion of the system. In one implementation, the Velocity-Verlet algorithm is utilized to integrate the equations of the motions. In this algorithm, the time is discretized and the equation of motion is integrated over short discrete time steps Δt, the position \vec{x}(t), the velocity \vec{v}(t), and the acceleration \vec{a}(t) of a moving particle are integrated from the time t to the t+Δt in the following order:

$$\begin{matrix}\vec{v} ( t + \frac{1}{2} Δ t ) = \vec{v} ( t ) + \frac{1}{2} \vec{a} ( t ) Δ t & Eq . ( 15 ) \\ \vec{x} ( t + Δ t ) = \vec{x} ( t ) + \vec{v} ( t + \frac{1}{2} Δ t ) Δ t & Eq . ( 16 ) \\ \vec{a} ( t + Δ t ) = \frac{1}{m} \vec{f} [ \vec{x} ( t + Δ t ) ] & Eq . ( 17 ) \\ \vec{v} ( t + Δ t ) = \vec{v} ( t + \frac{1}{2} Δ t ) + \frac{1}{2} \vec{a} ( t + Δ t ) Δ t & Eq . ( 18 )\end{matrix}$$

A sequence of these integration could bring the system from t=0 into t=T_{final} where T_{final}=nΔt and in is the total number of the integrations. As a result of the implementation of Equations (15)-(18), prior to updating the forces of system in a third step 1103, the velocities of the system are updated in a first step 1101 and the positions of the system are updated in a second step 1102. In some implementations, this is the first updater of Velocity-Verlet in the software and imposes Equation (15) and Equation (16) to the system. After updating the forces of the system, there is also another updater which integrates the velocities 1104 and imposes Equation (18) into the system.

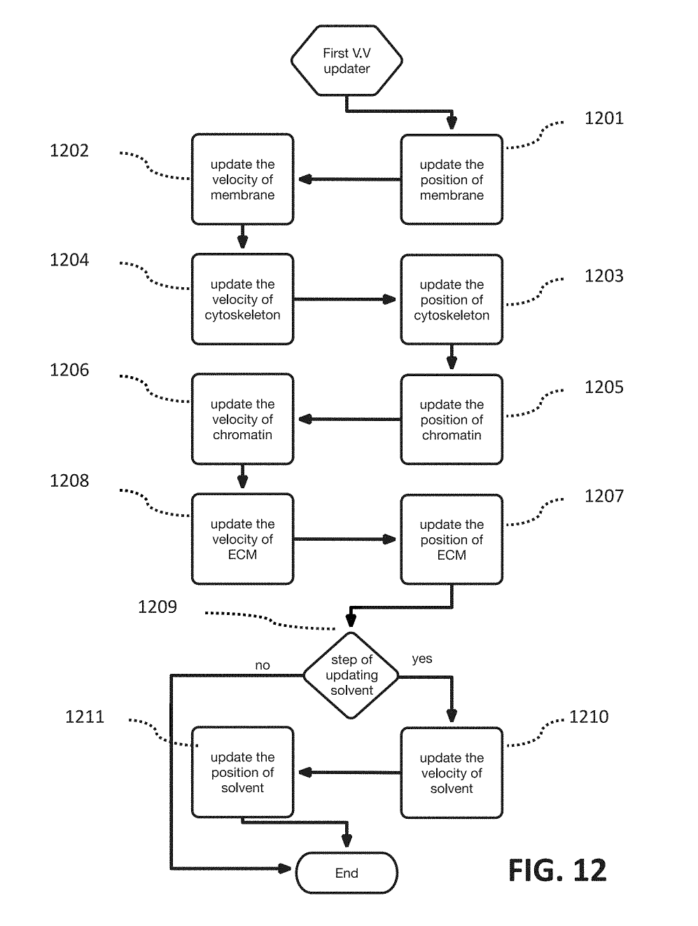

One implementation of a process of updating the system configuration in the first Velocity-Verlet updater is shown in further detail in FIG. 12. As shown in FIG. 12, a first step 1201 updates the position vectors of the membrane nodes, and a second step 1202 updates the velocity vectors of the membrane nodes. In addition, a third step 1203 updates the position vectors of the cytoskeleton nodes, and a fourth step 1204 updates the velocity vectors of the cytoskeleton nodes. Furthermore, a fifth step 1205 updates the position vectors of the chromatin beads and a sixth step 1206 updates the velocity vectors of the chromatin beads. This is followed by a seventh step 1207 that updates the position vectors of the ECM nodes and an eighth step 1208 that updates the velocity vectors of the ECM nodes. In different implementations, the updating of solvent particles takes place once every 25 steps, which is controlled during a ninth step 1209. This enables the updating of the position vectors of solvent particles in tenth step 1210 and the updating of the velocity vectors of solvent particles in an eleventh step 1211 in accurate time intervals.

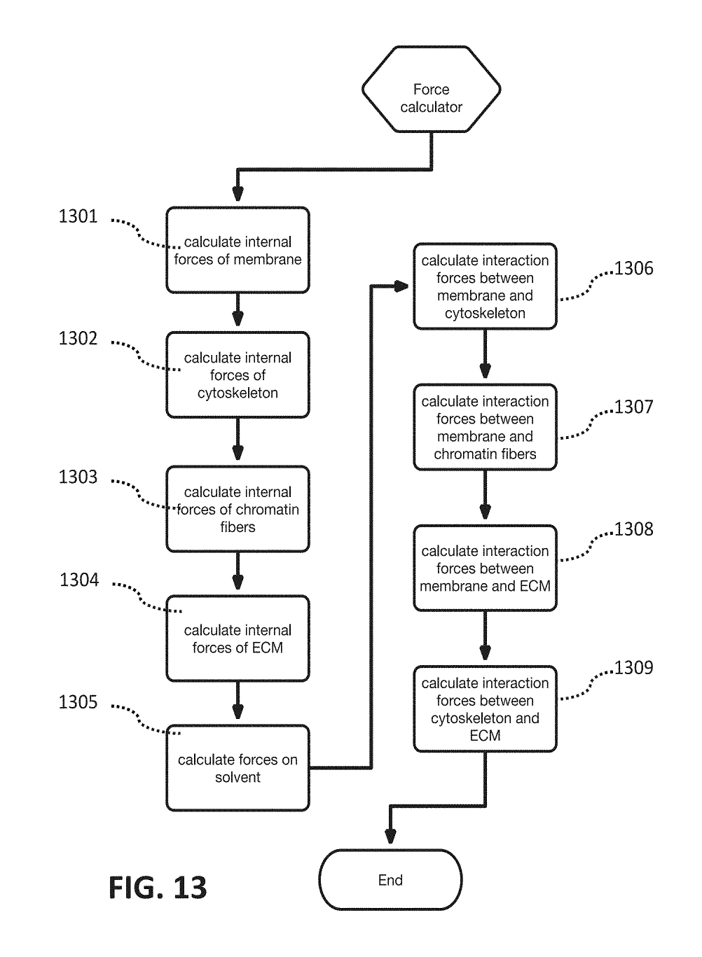

Additional details regarding the third step 1103 of FIG. 11 are provided with respect to FIG. 13. After performing the first Velocity-Verlet updater, as a result of the Velocity-Verlet integrating algorithm, the software begins to calculate the updated forces of the new configuration of the system. The force calculator sequence begins with calculating the internal forces of the membrane in a first step 1301, then the cytoskeleton in a second step 1302, chromatin fibers in a third step 1303, and the ECM in a fourth step 1304. If there is any force which should be imposed to the solvent particles, this occurs in a fifth step 1305. The calculation of interaction forces between different parts of the virtual cell begins with the calculation of interaction forces between the membrane and cytoskeleton in a sixth step 1306. In addition, the calculation of the interaction forces between the nucleus membrane and the chromatin fibers occurs in a seventh step 1307, between the cell membrane and the ECM in an eighth step 1308, and between the cytoskeleton and the ECM in a ninth step 1309 are performed respectively. The methods of force calculation will be explained next in more details.

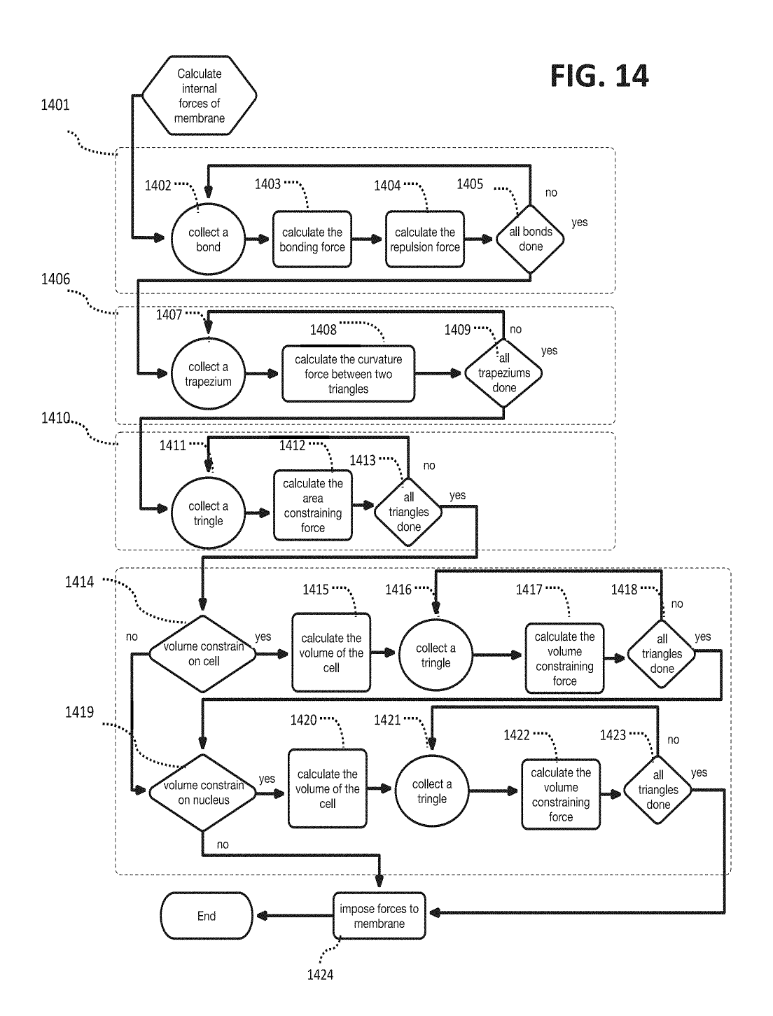

Referring back to Equation (1), in order to calculate the internal force in cell membranes, various types of forces with different origins should be considered. In one implementation, the subroutine depicted in FIG. 14 is responsible for calculation of all internal forces of membranes. As indicated by the first subroutine block, in step 1401 the bonding and repulsion forces on the membrane nodes are calculated. The origin of these forces is U_{bonding} and Uᵣₑₚᵤₗₛᵢₒₙ in Equation (1) and the explicit forms of these forces are obtained from the potential energy gradient. The calculation begins by collecting all bonds between neighboring nodes during steps 1402 and 1405. The bonding and repulsion parts of the force are calculated in steps 1403 and 1404. When all membrane bonding forces have been calculated, the curvature force is calculated in step 1406. All pairs of neighboring triangles (which build a trapezium geometry) are collected during steps 1407 and 1409, and the corresponding bending forces between pairs of triangles are calculated in step 1408. The area of the membrane is controlled by U_{surfacearea} in Equation (1), and the calculation of its corresponding forces is carried out in step 1410. All triangles of the cell and nucleus membrane are selected during steps 1411 and 1413. In addition, for each triangle, the forces are calculated for the three nodes of the triangles and stored in the force vectors by step 1412.

Furthermore, if a user has implemented any constraint on the volume of the cell 1414 or on the volume of the nucleus 1419, the procedure for implementation of the constraining forces will begin with the calculating the volume of targets in steps 1415 and 1420. Following this, all corresponding triangles in the target membranes are selected by steps 1416 and 1421 and steps 1418 and 1423. In addition, the constraining forces are calculated by steps 1417 and 1419. It should be noted that in different implementations, the force calculator subroutines in this software create vectors in local memories, sum up all forces for each target node separately in these vectors, and impose these forces on the targets. This process reduces the duration of these types of operations in the software. Finally, all stored forces in force vectors are imposed onto the membrane nodes in step 1424.

After the membrane forces have been computed, the internal forces of the cytoskeleton (see second step 1302 in FIG. 13 above) are calculated based on the above listed Equations (3)-(9). If the type of the linkages of the cytoskeleton is assigned as SMN (see 1501), all linkages will be chosen by steps 1502 and 1505 and the corresponding force will be calculated in step 1503. As described in Equation (3), the length of each linkage is then updated in step 1504, based on Equation (4). If the linkages are PCN 1506, all linkages will be chosen by steps 1507 and 1509 and the corresponding force is calculated in step 1508 as described by Equation (5) and Equation (6). In the case of ACN 1510, for all linkages which are collecting by steps 1511 and 1514, the force regime (due to the length of the linkage) and the forces are calculated by steps 1512 and 1513, as described by Equation (7), Equation (8), and Equation (9). Finally, all stored forces for the force vectors are imposed onto the cytoskeleton nodes in step 1515.

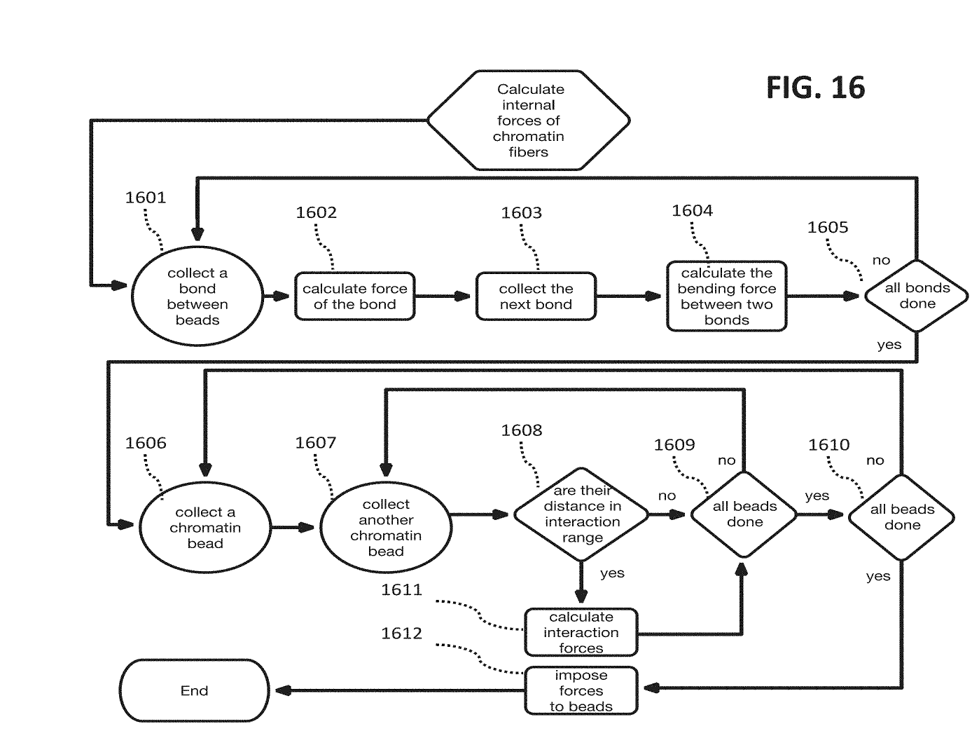

In FIG. 16, the calculation process of the internal forces of chromatin fibers (see step 1303 in FIG. 13) is illustrated in further detail. As described above in Equation (10), the internal forces acting on chromatin fibers include bonding, bending, and excluded volume. To calculate the bonding and bending forces, all existing bonds in chromatin fibers are selected during steps 1601 and 1605 of FIG. 16, and the bond force is then calculated in step 1602. To calculate the bending forces, the next bond is selected by step 1603, following which the bending forces between these two neighbors is calculated by step 1604. Excluded volume force could exist between any pair of chromatin beads whether they are connected to each other via a bond or not. Thus it can be necessary to include every pair of chromatin beads, which occurs during steps 1606 and 1610 and steps 1607 and 1609. Regarding Equation (10), if the distance between two beads is less than a specified distance (here, 1.12σ), the excluded volume force can be taken into account in step 1608, and the force is calculated by step 1611. Finally, all stored forces in force vectors are imposed onto the cytoskeleton nodes by step 1612.

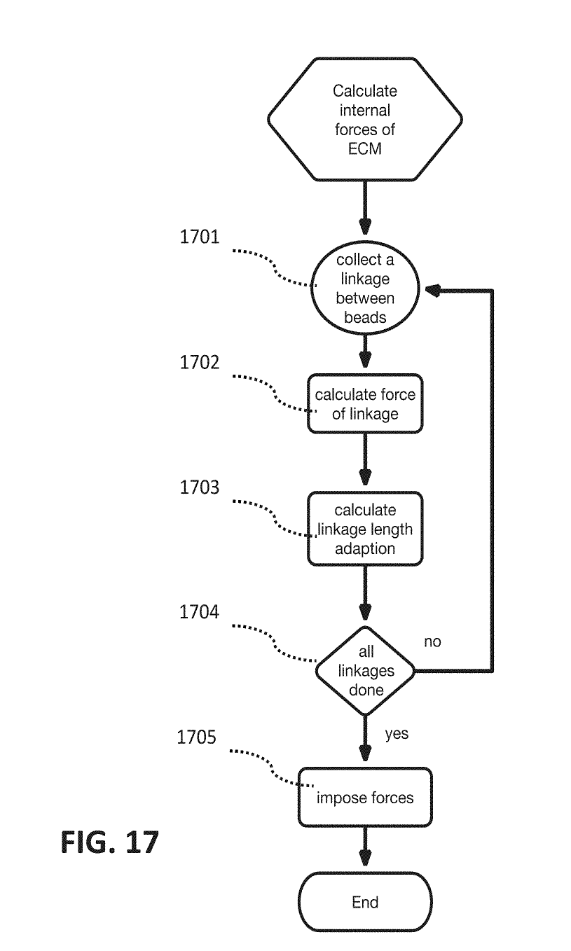

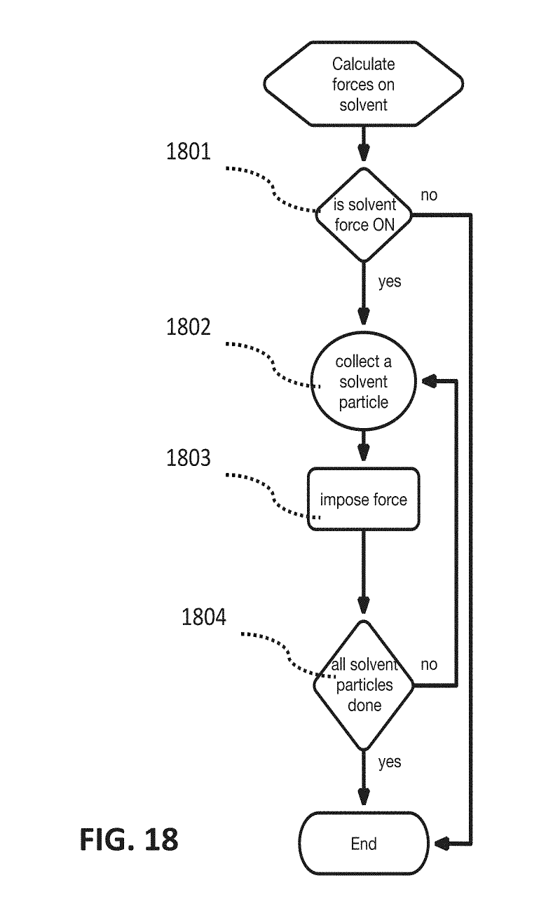

As noted earlier, internal forces of the ECM can be understood to be acting between connected nodes (see Equations (11) and (12) above). The subroutine illustrated next in FIG. 17 is responsible for the internal forces of the ECM. In this subroutine, all linkages are selected by steps 1701 and 1704. In addition, the force of the linkage is calculated by step 1702, and the length adaptation of the linkage is imposed by step 1703. Finally, all calculated forces are imposed onto ECM nodes. Furthermore, referring to FIG. 18, if external forces should be imposed on solvent particles 1801, steps 1802 and 1804 collect solvent particles and step 1803 imposes these forces to the solvent particles.

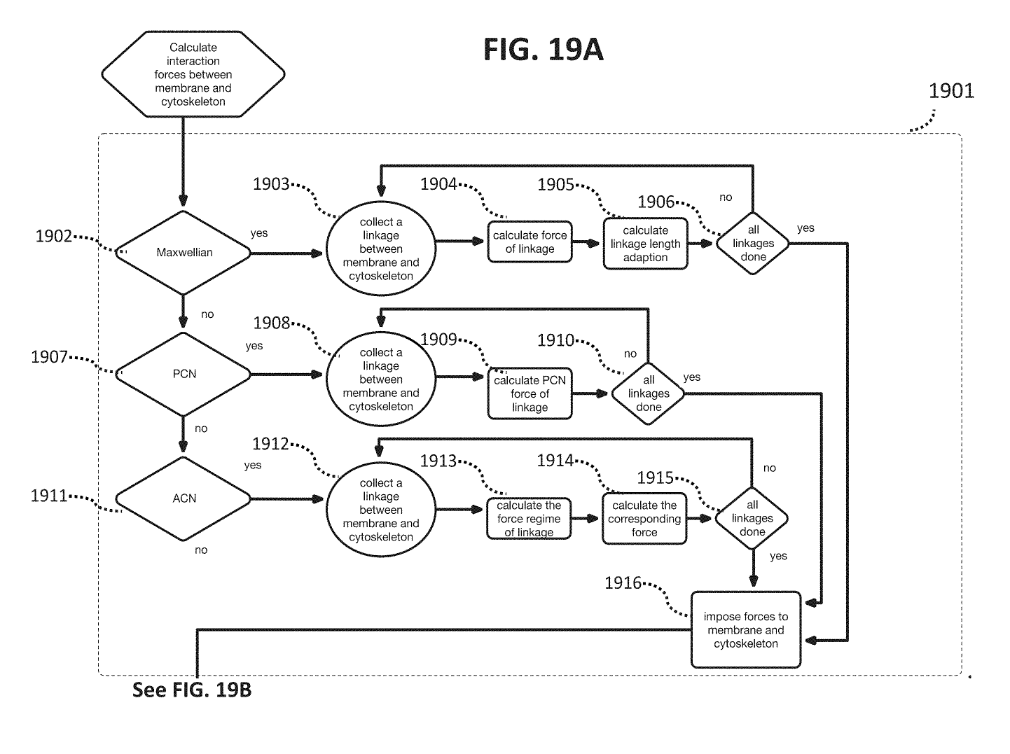

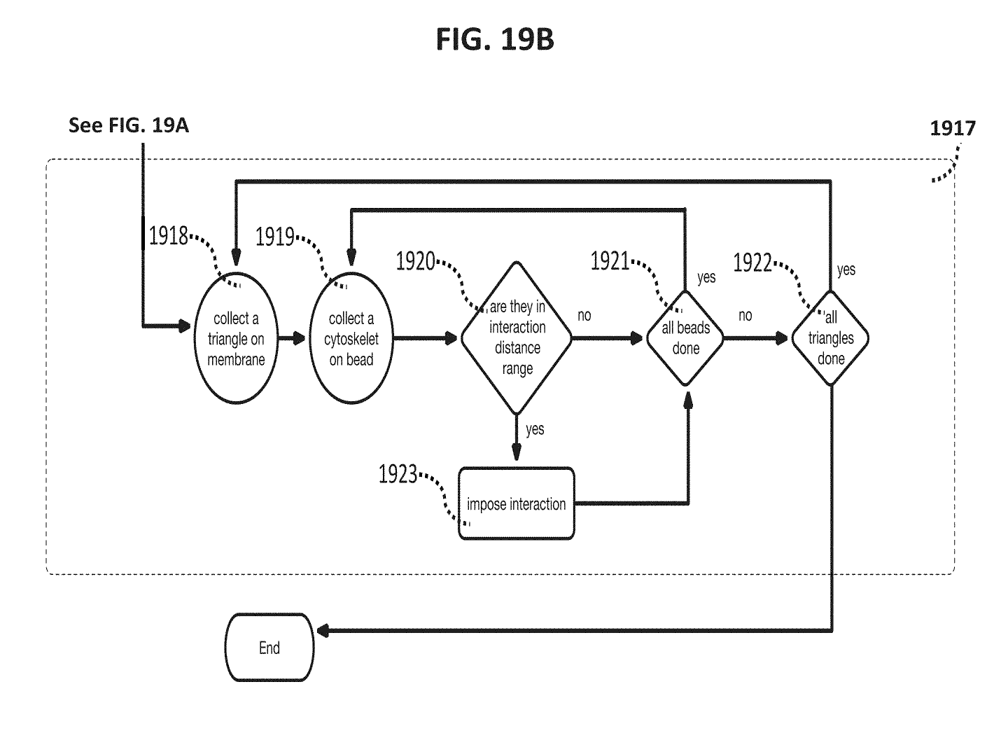

In different implementations, interactions between the membranes and the cytoskeleton are calculated in the subroutine as illustrated in FIGS. 19A and 19B. The membranes and cytoskeleton interact in two primary ways. First, some membrane nodes are connected to the cytoskeleton by linkages with the same characteristics as cytoskeleton linkages, and this force is calculated in a first section 1901 of the subroutine, depicted in FIG. 19A. Second, the membrane is impenetrable for the nodes of the cytoskeleton, and this causes another interaction which exhibits behavior similar to that of an elastic collision. This interaction is calculated in a second section 1917 of the subroutine.

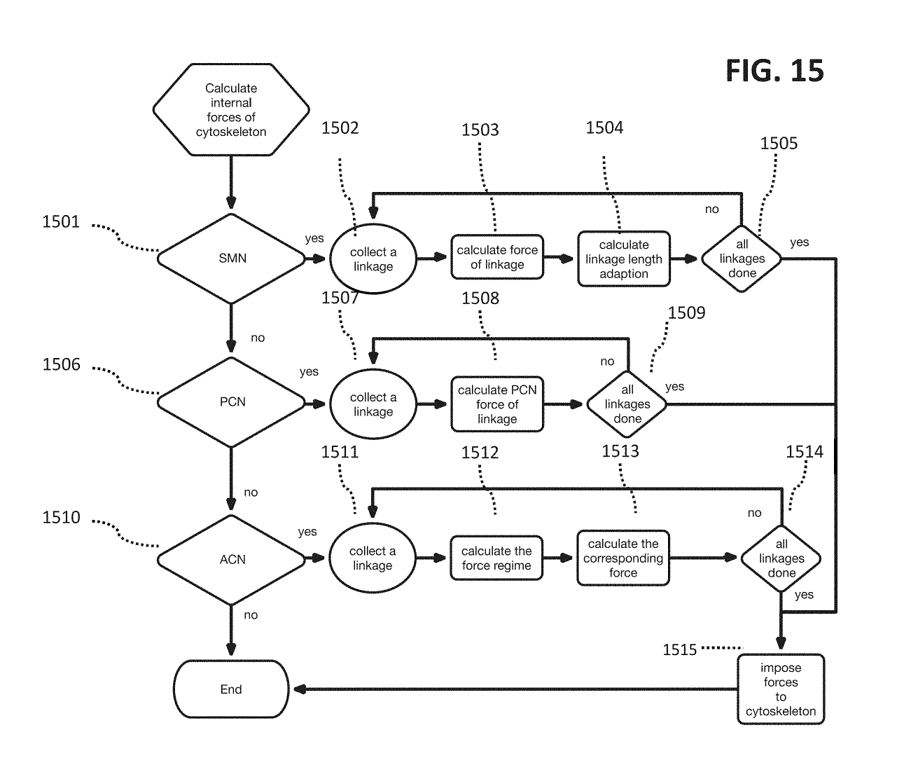

Referring again to the first section 1901 of the subroutine of FIG. 19A, steps 1902, 1907, and 1911 can determine the type of cytoskeleton (for example, SMN, PCN, or CAN). Steps 1903 and 1906, steps 1908 and 1910, and steps 1912 and 1915 are configured to select all existing bonds between the cytoskeleton and membrane nodes. Furthermore, steps 1904 and 1905 may be configured in a manner similar to steps 1503 and 1504 of FIG. 15, step 1909 may be configured in a manner similar to step 1508, and steps 1913 and 1914 may be configured in a manner similar to steps 1512 and 1513. At the conclusion of the first section 1901 the calculated forces are imposed on the cytoskeleton and membrane nodes by step 1916. In the second section 1917 presented in FIG. 19B, the process includes steps 1918 and 1919, and steps 1921 and 1922, in which all pairs of cytoskeleton and membrane nodes are selected. The distance is checked by step 1920, and if they are close enough to interact with each other, collision is implemented between them by step 1923.

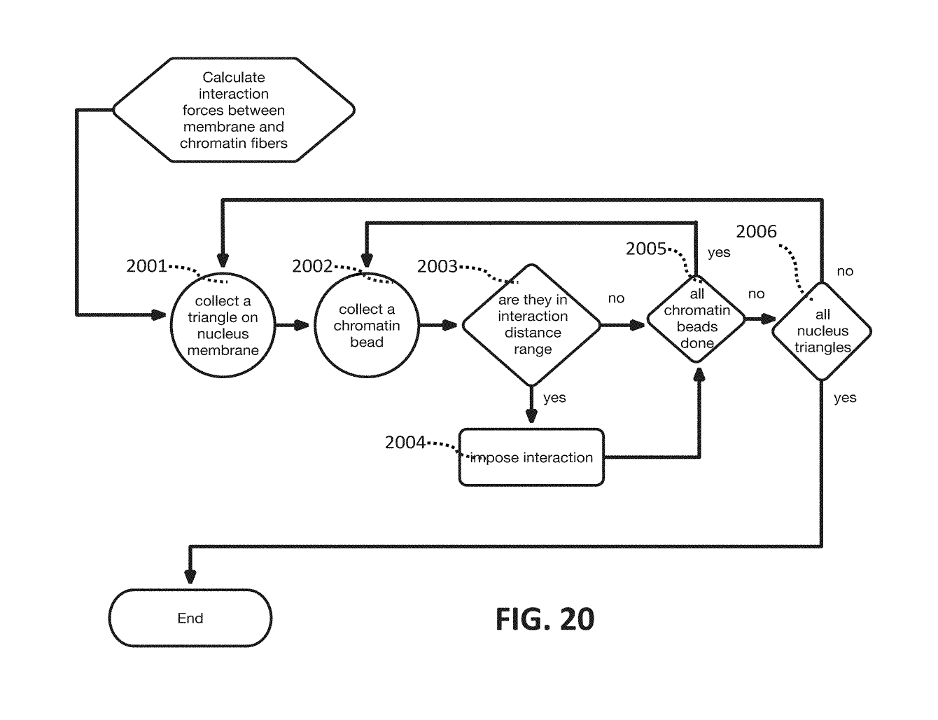

FIG. 20 illustrates the interaction between chromatin fibers and nucleus membrane. During steps 2001 and 2005 all triangular elements of nucleus membrane are selected and during steps 2002 and 2006 all chromatin are selected. Furthermore, during step 2003 the distance between the chromatin bead and nucleus triangle is calculated, and if they are close enough to interact with each other, a collision is set between them by step 2004.

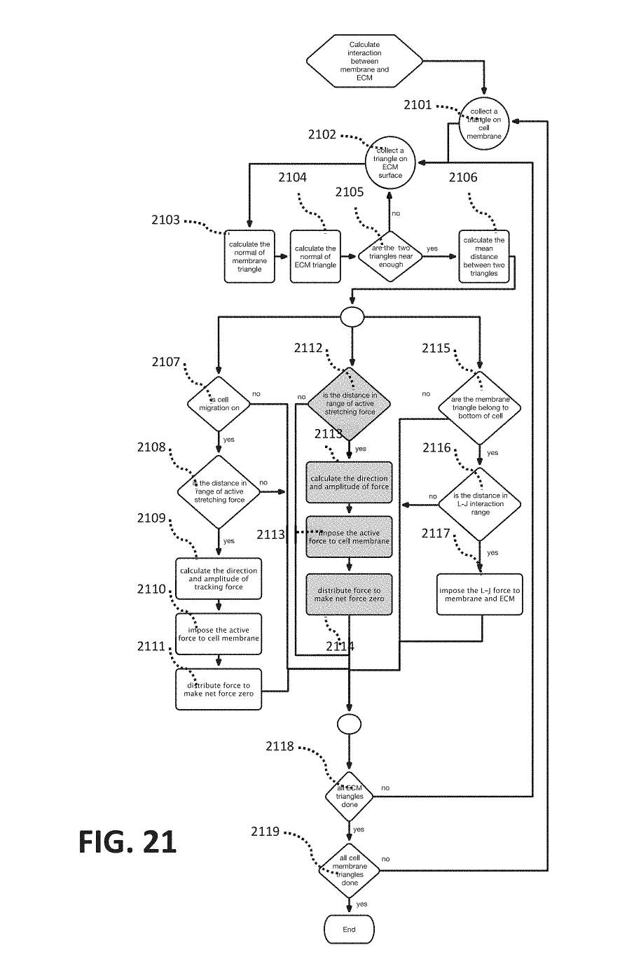

An implementation of a method of implementing interactions between the cell membrane and ECM is illustrated in a flow diagram in FIG. 21. As shown in FIG. 21, during steps 2101, 2102, 2118 and 2119 all pairs of membrane-ECM triangles are considered. For each triangle the outward pointing normal is calculated by steps 2103 and 2104. During step 2105 a determination as to whether two triangles are close enough to each other is made. If they are sufficiently close, their distance is calculated in step 2106. In step 2107 the method ascertains if the cell is a migrating cell (see fifth step 405 in FIG. 4), and in step 2108 the interaction range is checked. If the interaction range is true, step 2109 calculates the direction and amplitude of the tacking force, step 2110 imposes forces onto membrane nodes, and step 2111 ensures the conservation of momentum in the system. Meanwhile, the active stretching force between the same triangles is calculated in steps 2112 to 2114. With respect to the normal vector of membrane triangle, if the triangular sheet belongs to the bottom of the cell 2115 and the distance between two triangles is in the range of the Lennard Jones (LJ) force 2116, a simple LJ force is imposed to both membrane and ECM triangles in a step 2117.

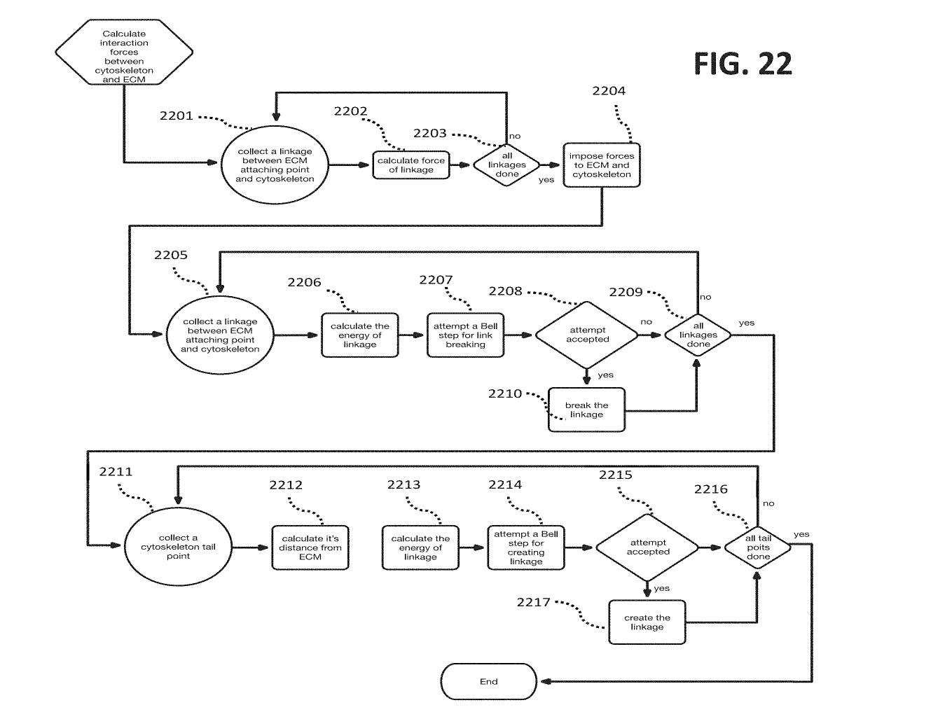

In different implementations, the ECM and the tails of the cytoskeleton network could be bonded to each other via effective focal adhesions. This is simulated by simple spring mechanisms. Referring now to the implementation of FIG. 22, steps 2201 and 2203 select all existing bonds between ECM and cytoskeleton. In addition, step 2202 calculates the force vector, and step 2204 imposes the force vectors to corresponding ECM and cytoskeleton nodes. The corresponding bond dynamics are implemented in steps 2205 to 2217. Furthermore, steps 2205 and 2209 select all existing bonds, and the bond energy is calculated in step 2206. During step 2207, the bond is broken based on the rule in the Bell mechanism, which is based on the following probability:

$${P}_{unbond} = {e}^{- \frac{{U}_{unbond}}{{K}_{B} T}} \qquad Eq . ( 19 )$$

If the attempt is accepted, step 2210 breaks the bond. However, the bonds may be formed with another Bell attempt. Thus, during steps 2211 and 2216 all tails of the cytoskeleton network are selected, and step 2212 calculates its distance from the ECM. Next, step 2213 calculates the bonding energy of possible linkage with the ECM, and step 2214 initiates a Bell process to form the new bond (if a bond does not exist already), with a probability of:

$${P}_{bond} = {e}^{- \frac{{U}_{bond}}{{K}_{B} T}} \qquad Eq . ( 20 )$$

If the attempt is accepted, step 2217 forms the bond.

Referring next to FIG. 23, a step 2301 is configured to implement the collision step once every 25 molecular dynamics steps. Steps 2302 and 2305 are configured to select all lattices. Furthermore, step 2303 determines the particles inside the box, and step 2304 imposes Equation (13) to all particles (including solvent particles, membrane nodes and chromatin beads) inside the lattice.

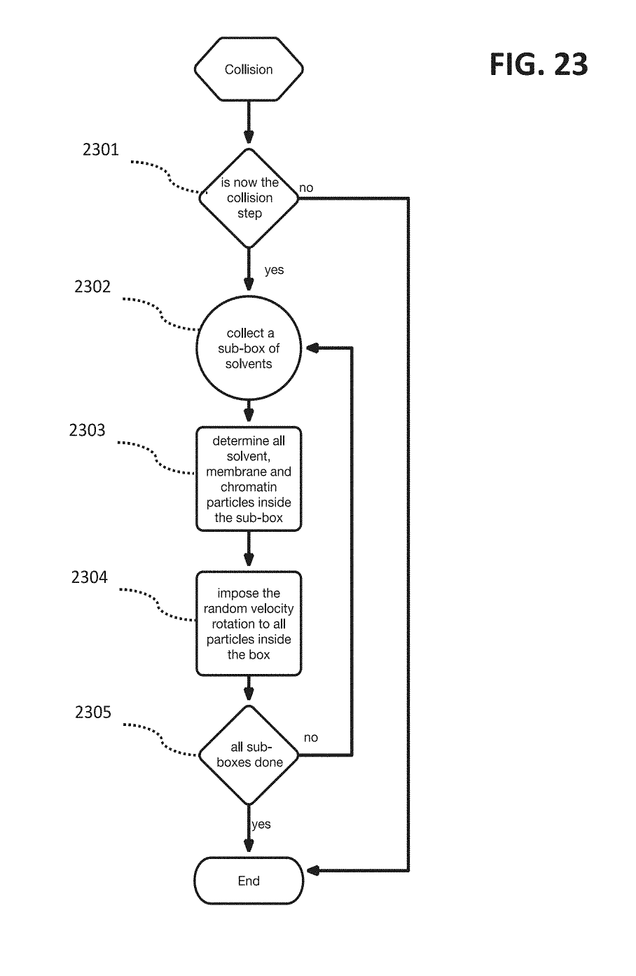

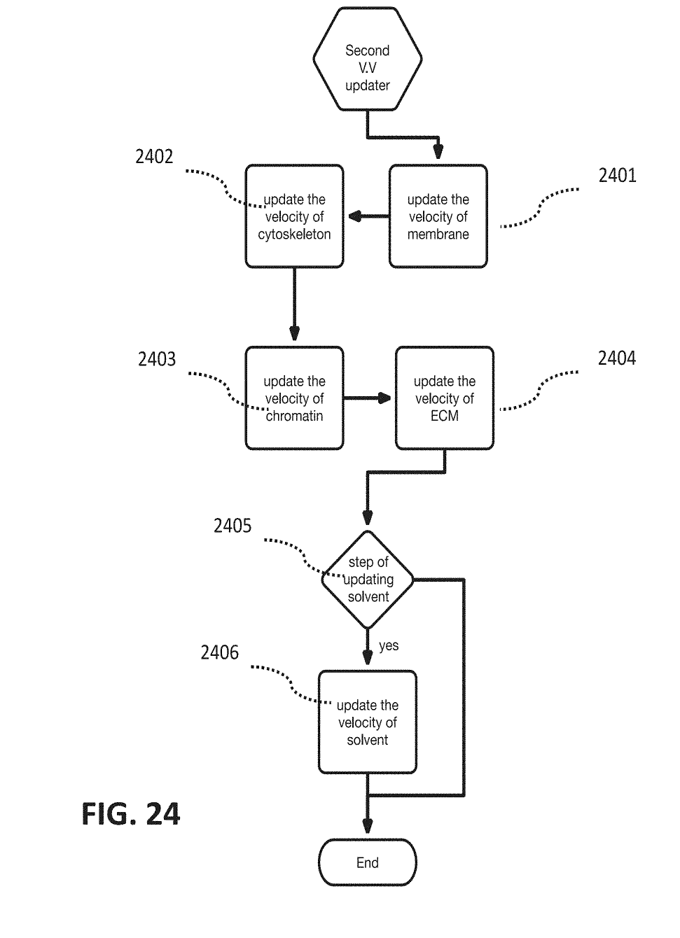

Updating the system configuration in the second Velocity-Verlet updater is shown in more detail in FIG. 24. In FIG. 24, a step 2401 updates the velocity vectors of the membrane nodes, and a step 2402 updates the velocity vectors of the cytoskeleton nodes. In addition, a step 2403 updates the velocity vectors of the chromatin beads, and a step 2404 updates the velocity vectors of the ECM nodes. The updating of solvent particles is configured to occur once every 25 steps, which is controlled by step 2405, while step 2406 updates the velocity of the solvent particles.

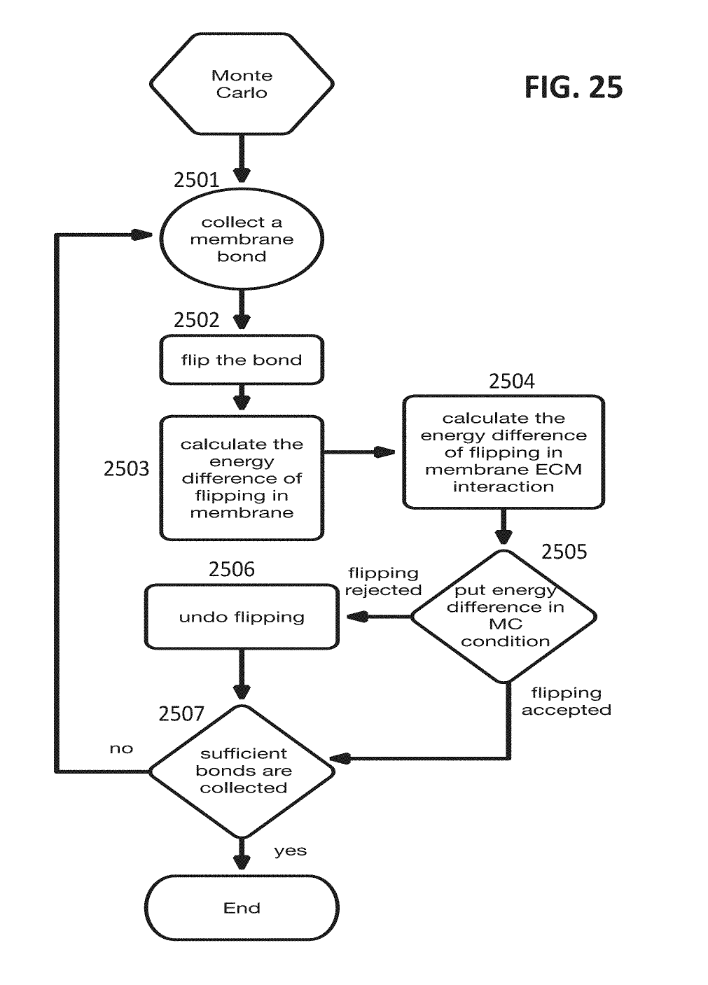

The fluidity is induced in the membranes by Monte Carlo moves over flipping the connectivity network of the triangulated surface. Referring to FIG. 25, steps 2501 and 2507 are configured to randomly collect sufficient bonds in membranes, and step 2502 flips the bond temporarily. A step 2503 calculates the generated energy difference in membrane by bond flipping, where the source of this energy difference can be expressed by Equation (1). Step 2504 is configured to calculate the generated energy difference in membrane-ECM interaction by bond flipping, where the source of this energy difference is expressed by Equation (13). A step 2505 attempts a permanent bond flipping with the probability expressed in Equation (2). If the attempt is accepted, step 2506 applies this change, including updating bonds, triangles and trapeziums.

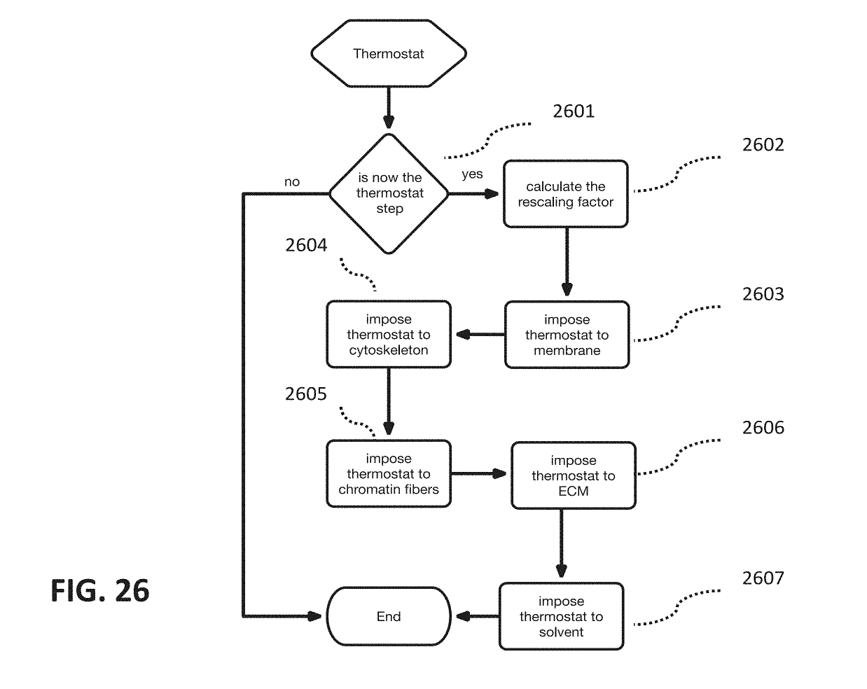

The illustrated subroutine in FIG. 26 imposes a velocity-rescaling thermostat to the system at constant time intervals during step 2601. This method is configured to rescale the velocities of all local particles by a factor α, which is calculated via:

$$α = \sqrt{\frac{{K}_{B} {TN}_{df}}{2 {K}_{lattice}}} , \qquad Eq . ( 21 )$$

where N_{df} is the numbers of degrees of freedom of the lattice and K_{lattice} is the current total kinetic energy of the lattice. The rescaling factor is calculated in step 2602. Furthermore, steps 2603 to 2607 multiply the velocities of membrane, cytoskeleton, chromatin fibers, ECM and solvent particles by the rescaling factor.

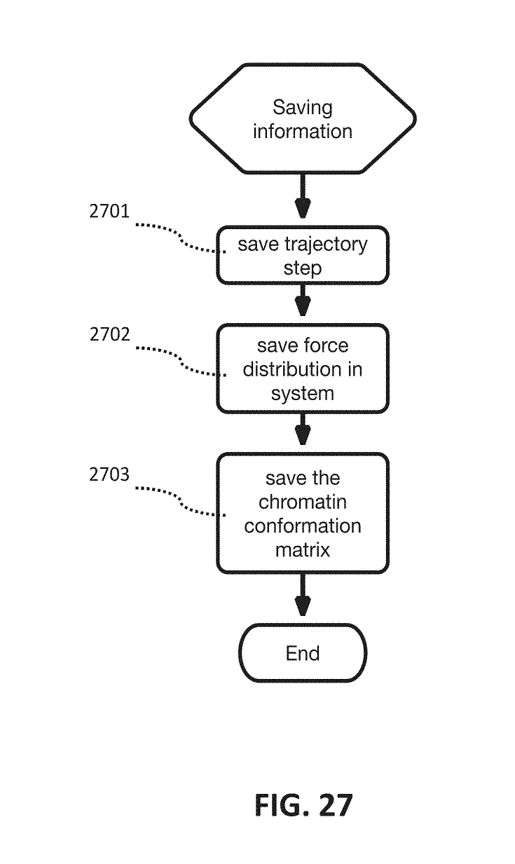

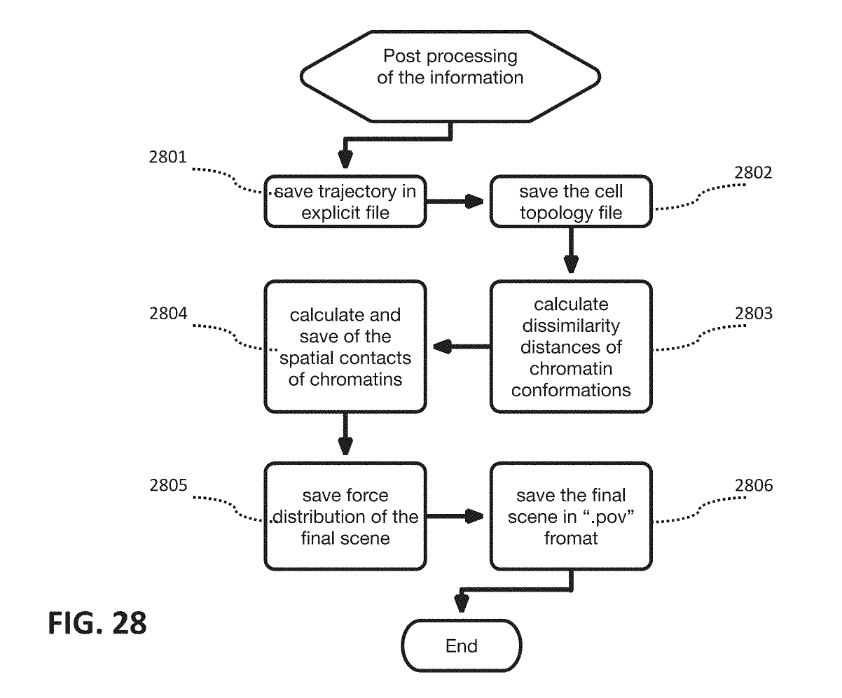

At the end of each MD step, a subroutine saves corresponding information (see 1108 of FIG. 11). Step 2701 of FIG. 27 is configured to save the trajectory or position and velocity vectors of the system, step 2702 saves the force distribution in the system, and step 2703 saves the chromatin conformation matrices. After the MD loop is completed, post-processing of the information begins (see 306 of FIG. 3). Referring to FIG. 28, step 2801 is configured to save the trajectory with desired details in an explicit file, while step 2802 saves the topology of the system configuration in an explicit file. Furthermore, step 2803 calculates the dissimilarity distance of chromatin conformations, and step 2804 saves the average spatial contacts of chromatin fibers. Finally, step 2805 saves the force distribution of the final configuration and step 2806 saves a graphical file of the final configuration.

### Example 1: Prediction of Cell and Nucleus' Geometries on Grooved Substrates

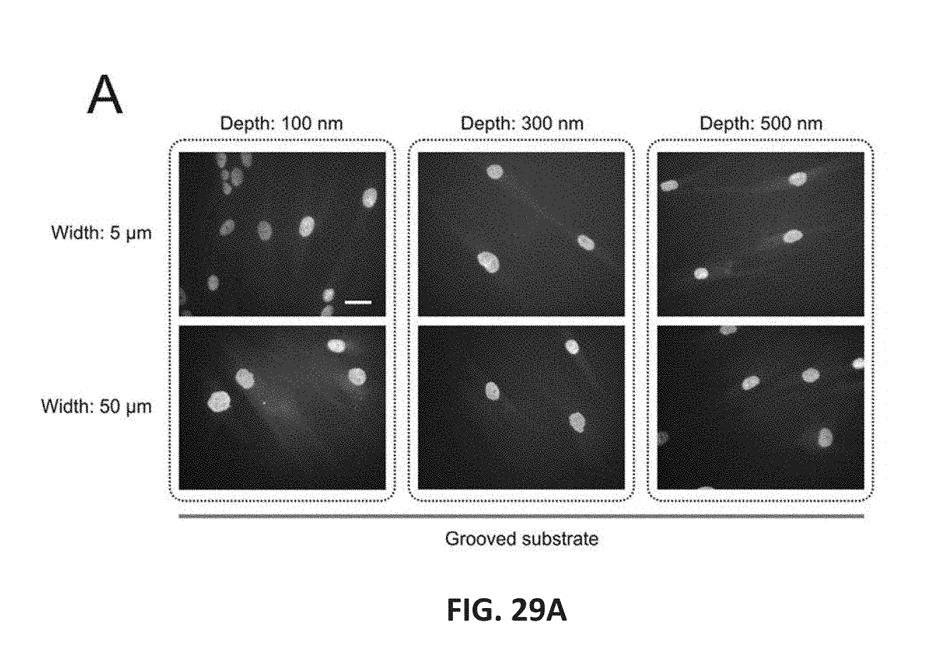

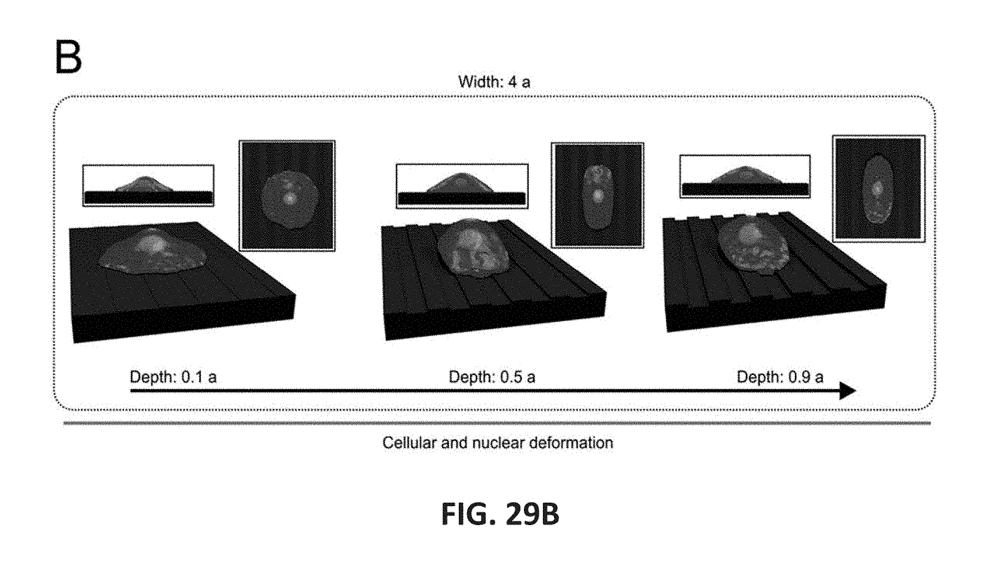

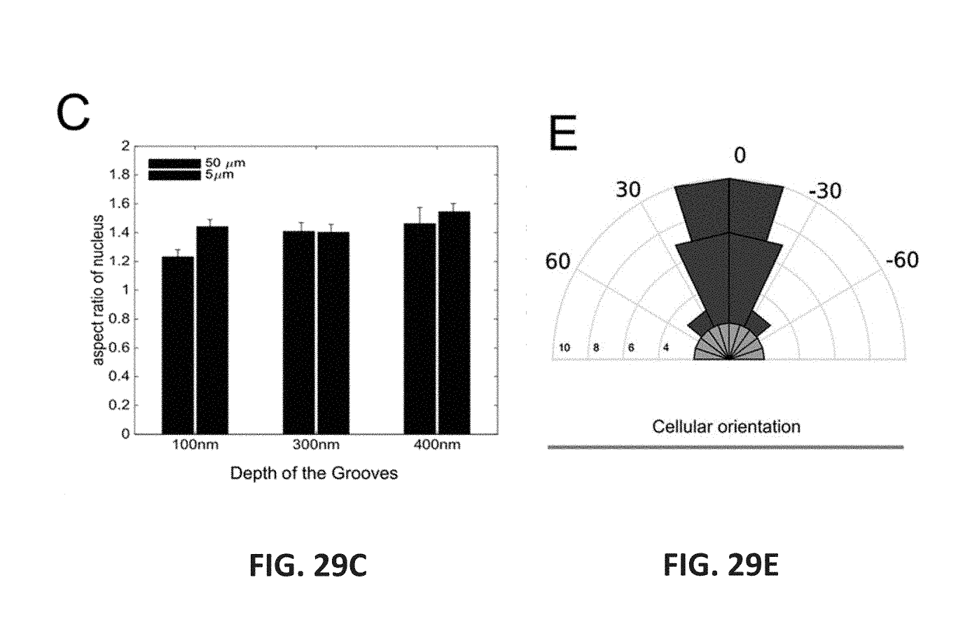

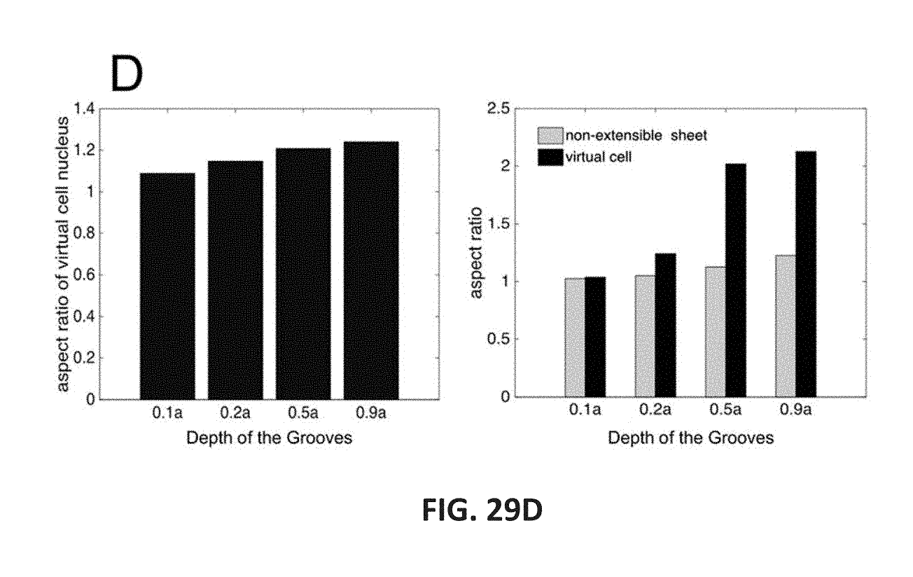

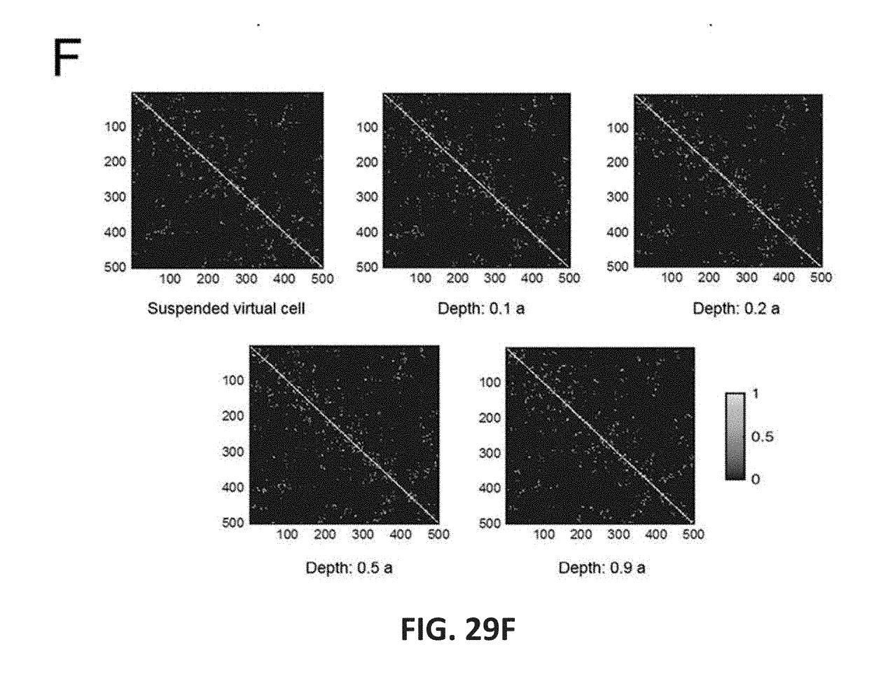

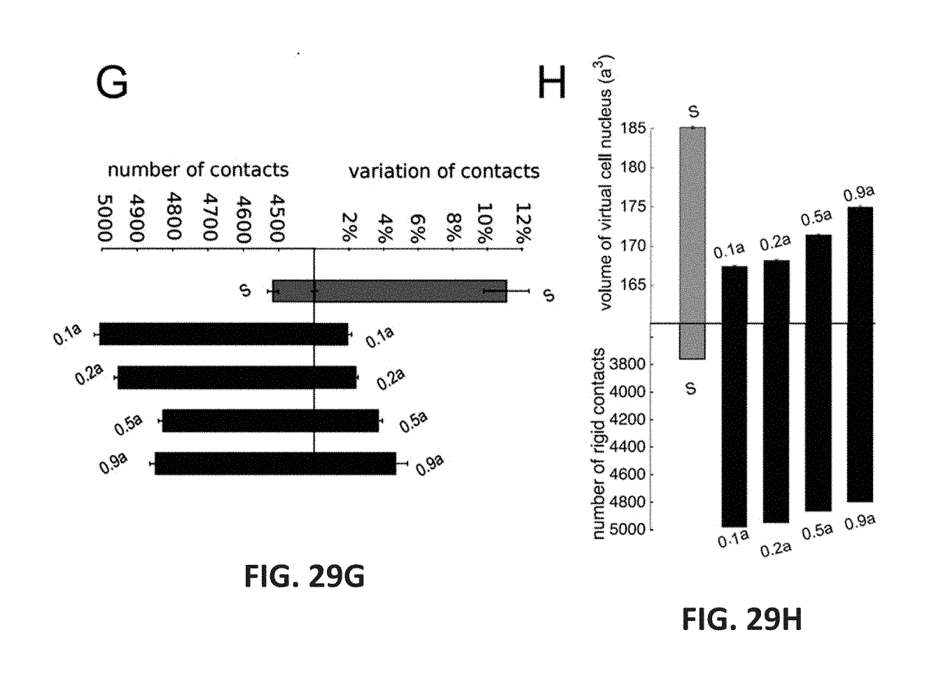

It is generally understood that microgrooved patterns can guide cell elongation with width and depth of the grooves dictating the degree of alignment. Further, it has previously been observed in elongated nuclei that signaling interactions at the nuclear membrane show an increase in activated signaling components, providing the shape as an indicator of “cell health”. In Example 1, grooved patterns were fabricated on poly(methyl methacrylate) (PMMA) substrates with various widths and depths (specifically widths of 5 and 50 μm and depths of 100, 300, and 400 nm). These parameters were selected to give the cells strong guidance cues (narrow and deep grooves) and weak guidance cues (wide and shallow grooves). After culturing of the MSCs on the grooves at a seeding density of 1×10⁴ cells per sample in complete media for 4 days, MSCs were fixed and stained for actin cytoskeleton and DAPI (nucleus stain) as described (see FIG. 29A). The artificial cell was experimented on a model substrate to illustrate the capability of the developed model for predicting cell elongation on the grooved substrates (FIGS. 29A-29H). To measure elongation, the aspect ratio of the cells and nuclei was calculated by measuring the ratio of the larger to the smaller diameter of the fitted ellipses to the cell or nucleus. The results revealed that the virtual cell became elongated along the grooved substrate with elongation increasing with direct proportionality to increased groove depth (see FIG. 29B).

The virtual cell also elongated along the grooves, and this led to change in nuclear morphology from spherical to ellipsoidal, which was also seen in the cell cultures (see FIGS. 29A and 29B). The observed ellipsoidal shape of the nucleus is likely due to the propagation of stress from the outer membrane to the nucleus via the viscoelastic cytoskeleton and cytoplasm medium. In some implementations, a part of the measured cell elongation, cell aspect ratio, could be caused by the effect of attachment of the cell to the vertical walls of the substrate. In some cases, it can be observed that this is similar to elongation in visible cross-section of a “nonextensible circular wallpaper” when it covers the grooved substrate. The circular “wallpaper”, after covering the grooved substrate, looks like an ellipse with the aspect ratio as a function of the depth and the width of the grooves. However, the observed elongation of the virtual cell is greater than this geometrical effect, as shown in FIG. 29D.

The effect of grooved substrates on nuclear orientation was also investigated. It was found that the anisotropic virtual cells can adopt the shape of the substrates' grooves and thus orient along the groove direction. The degree of orientation is directly correlated to the increase in groove depth (see FIG. 29E).

In some cases, large-scale cell shape changes have dramatic consequences on the nuclear shape and structure, resulting in a chromatin condensation. This deformation in the nucleus can consequently alter the spatial configuration of the chromatin fibers and may change the cell behavior and fate. To gain more insight into how chromatin reorganization may be influenced by the nuclear shape remodeling, the probability of contact between all pairs of chromatin beads (in other words, fibers are modeled with bead-spring chains) in relaxed configurations was calculated and stored in contact probability matrices for the suspended virtual cell and the virtual cell on each groove depth (see FIG. 29F). The results showed that cell attachment and elongation can change the pattern of spatial contacts between different sections of the chromatin fibers. As illustrated in FIGS. 29G and 29H, while increasing groove depth led to a larger volume of the nucleus, when the suspended virtual cell (denoted by “S”) was absorbed on the substrate, the volume of the nucleus significantly decreased. As a consequence, the number of contacts between chromatin beads increased. On the other hand, since there was less available volume inside the nucleus after absorption, the percentage of the changed contacts decreased, and as a result the number of robust (rigid) contacts increased. Thus, the virtual cell model suggests that the cell absorption on the substrate creates more stable contacts (or exposures) between different parts of the chromatin fibers, and the strength of this effect depends on the substrate configuration

### Example 2: Cell-Substrate Stiffness Modeling Using a 3D-Elastic Network

It is generally understood that cells exist in a dynamic mechanical environment where they are subject to a wide range of forces, including mechanical stretching. The interactions at the cell-ECM biointerface can trigger a range of responses that regulate cell fate. The process of sensing dynamic changes (both changes in ECM stiffness and externally applied mechanical stretch) by cells is referred to as mechanotransduction. As discussed above, cell shape and function (for example, survival, growth, and differentiation) can be linked to substrate stiffness. Understanding how cells can sense the matrix stiffness through computational 3D-modeling with simulated features will help to design optimal scaffolds to accelerate translational research in biology and tissue engineering.

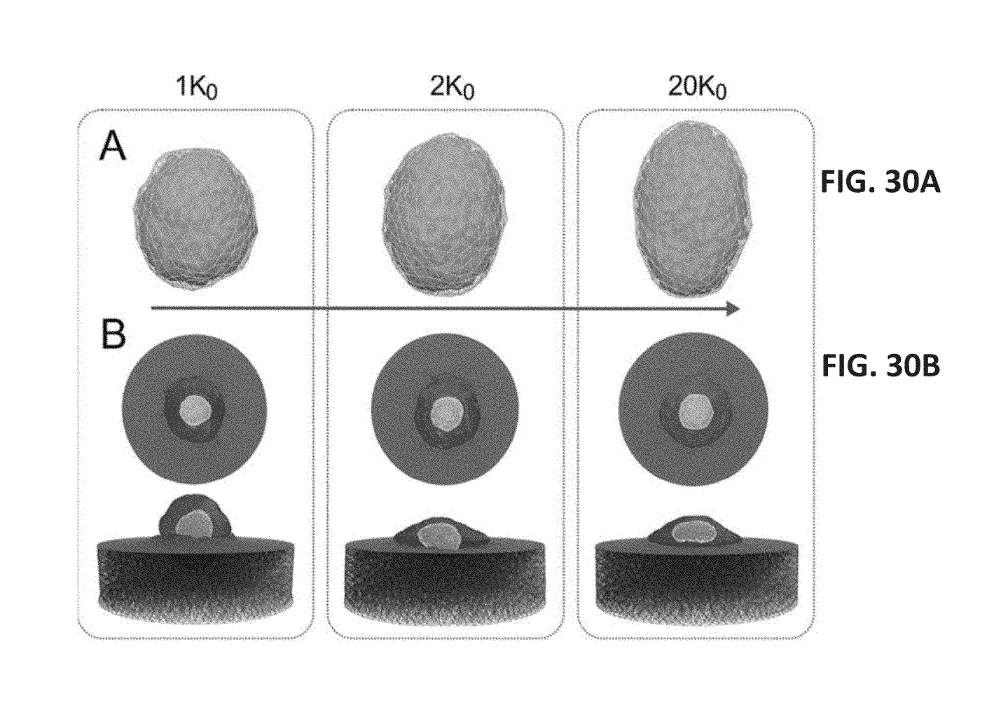

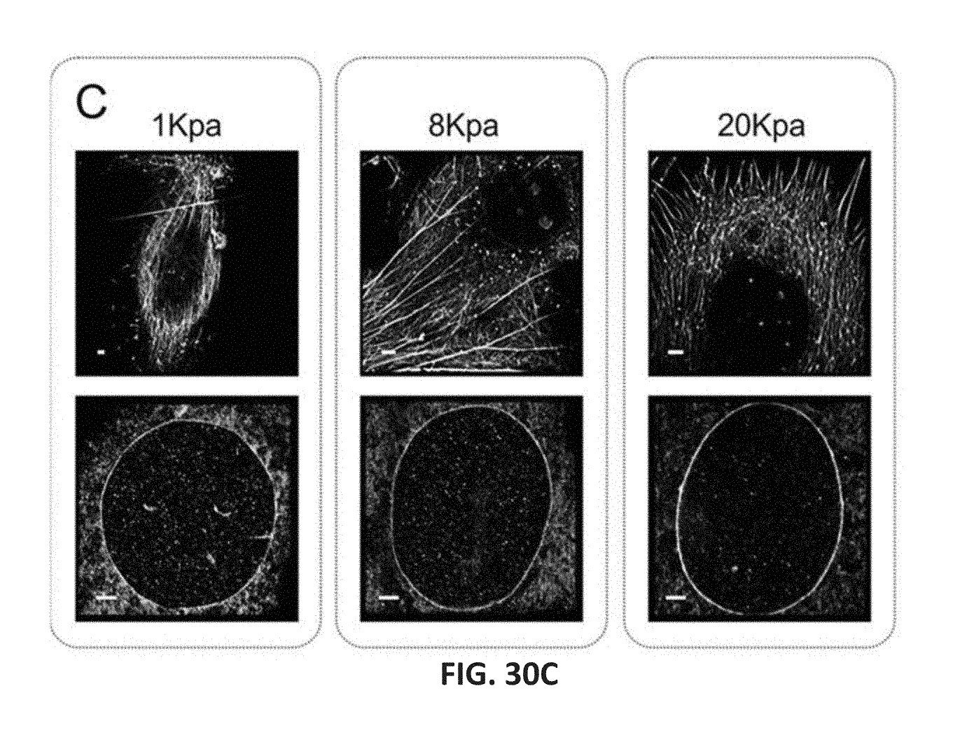

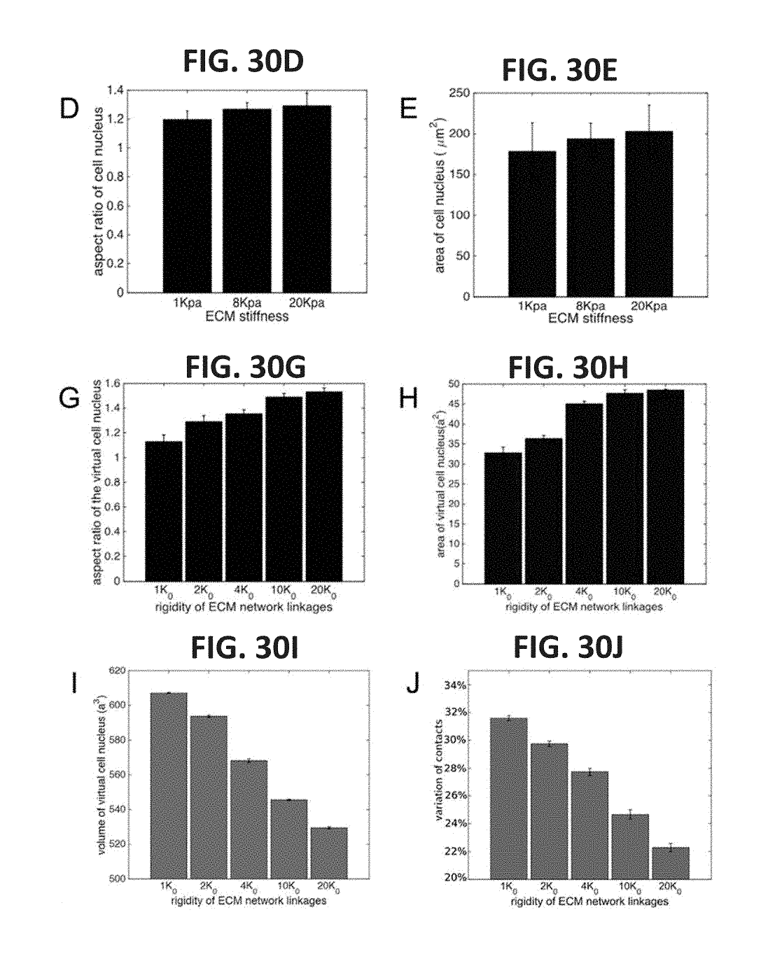

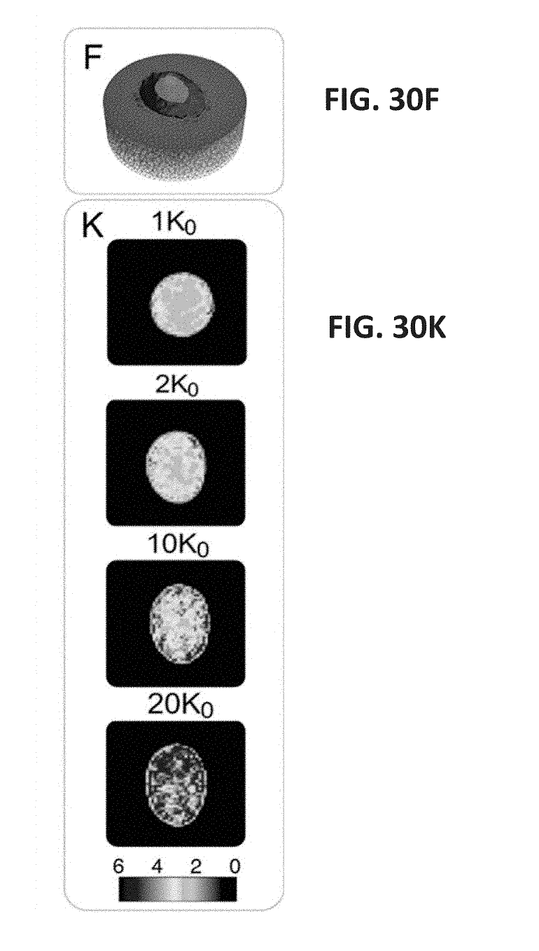

In Example 2, in order to study virtual cell response to ECM elasticity, anisotropic virtual cells (virtual cells with one arbitrary preferable direction of elongation) were placed on simulated substrates with different stiffness (see FIGS. 30A and 30C). Because the elastic network model was utilized for the substrate, the stiffness of the substrate depends on the elastic modulus of the network linkages, which varies from 1 k₀ to 20.0 k₀, where k₀ is the parameter of elasticity in simulation units). Furthermore, 3D-elastic networks with triangular shapes were employed to mimic a virtual cell interaction with an elastic substrate (see FIGS. 30B and 30F).

Experimentally, stochastic optical reconstruction microscopy (STORM) images were employed to probe the applicability of the virtual cell model. It is noteworthy that STORM images were generated by superlocalizing the positions of ˜106 single molecules collected over ˜50,000 frames of raw single-molecule images. The interaction of cells on polyacrylamide (PA) gel substrates with different stiffness (1, 8, and 2 kPa) was probed in terms of the effect of substrates on the cell nucleus shape. These stiffness values were chosen as they are known to differentially regulate MSC fate from neural to myoblastic to osteoblastic differentiations, respectively. It should be noted that the modulus of elasticity of the ECM is referred to in a biological context as stiffness. In FIG. 30E the nucleus spreading area on the ECM substrates is illustrated, showing that a “stiffer ECM” caused an increase in nucleus spreading. Moreover, localized shape deformation of the cell nucleus was associated with an increase in substrate stiffness (see FIGS. 30C and 30D). On the basis of the in-silico analysis, cell nucleus aspect ratio, as a measure of nucleus elongation, as well as nucleus area was observed to increase on stiffer substrates (see FIGS. 30G and 30H).

As a consequence of elongation, the virtual cell nucleus on the stiffer ECM model had less volume (see FIG. 301), potentially reducing the available space for chromatin inside the nucleus. As a result, the chromatin density inside the virtual nucleus and the number of contacts between chromatin segments increased in direct proportionality to reduced nuclear volume (see FIG. 30K). However, the modeled percentage of changes in chromatin contacts decreased on stiffer ECMs (see FIG. 30J). This suggests that the contacts between the chromatin segments are more stable in higher chromatin density conditions, such as with stiffer ECM. The results of Example 2 provide evidence that the “virtual cell model” can be successfully employed as a platform to understand how cells sense and respond to the ECM.

### Example 3: Prediction of Stem Cell Geometry and Chromatin Conformation on Cell-Imprinted Substrates

As described herein, a platform technology of smart nanopatterned substrates is disclosed. Such substrates are embossed with morphologies of mature cells. In response to these morphological outlines, MSCs differentiate into the cell type represented in the imprints. The success of these bioinspired cell-imprinted substrates for reliable and efficient control of MSC differentiation toward chondrocytes and keratinocytes has been discussed above. In addition, it has been demonstrated that cell-patterned substrates modulate the growth (self-renewal), differentiation, and dedifferentiation of a variety of cells.

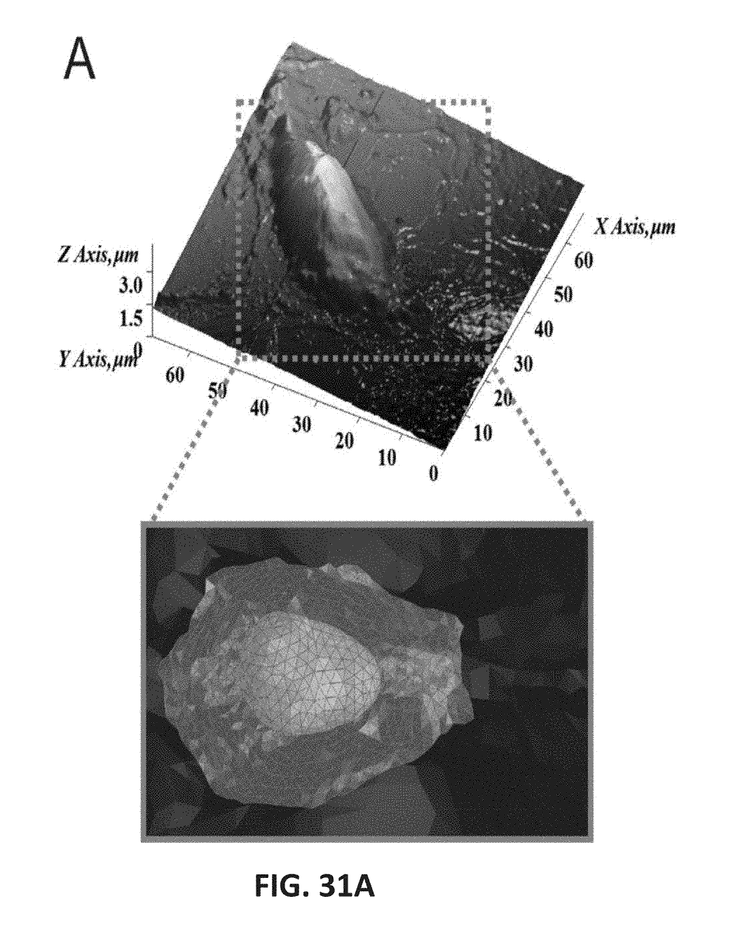

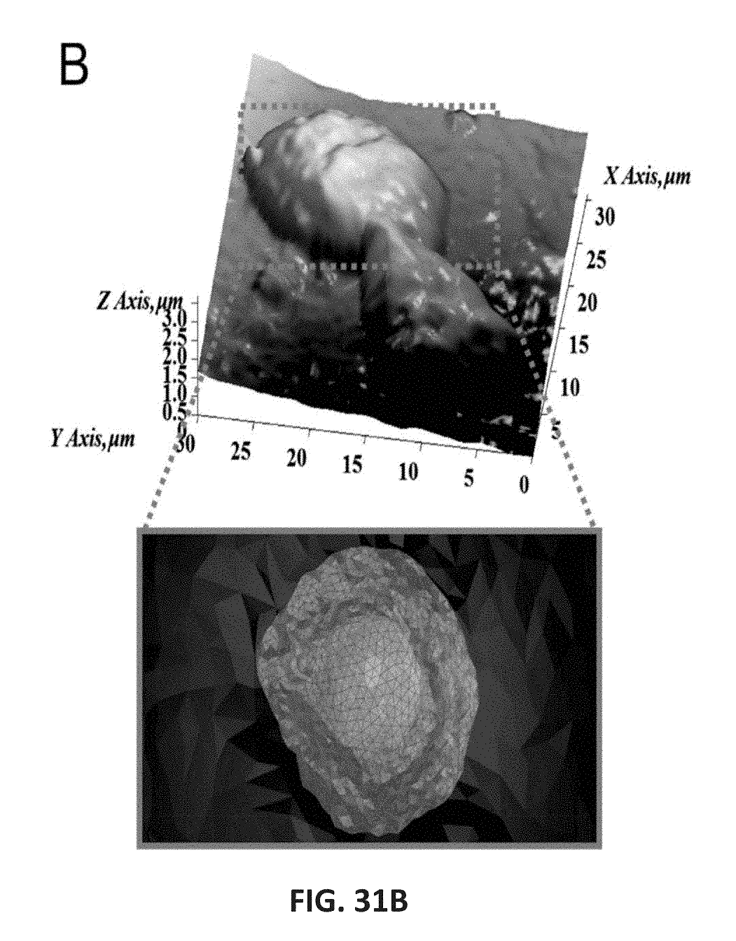

To investigate the efficacy of the disclosed virtual cell approach to predict the stem cell geometry after being cultured on the surface of cell-imprinted substrates, the morphologies of the imprinted substrates were directly captured from published experimental data. The resultant morphologies were then discretized into triangular elements and inserted into an implementation of the simulation model pipeline. The virtual cells were then placed above these substrates close enough to permit attachment. The results revealed that the virtual cell could accurately predict the geometry of the cultured MSCs according to the cell type that had been used as a template (see FIGS. 31A and 31B). More specifically, the simulation outcomes for culturing the cells on top of imprints designed around either naïve MSCs (typically fibroblastic in appearance, as shown in FIG. 31A) or dedifferentiated chondrocytes (reverted to fibroblasts) revealed the formation of bipolar, fibroblastic morphology and elongated nuclei, as described in the experimental papers (1) Mahmoudi, M.; Bonakdar, S.; Shokrgozar, M. A.; Aghaverdi, H.; Hartmann, R.; Pick, A.; Witte, G.; Parak, W. J., Cell-Imprinted Substrates Direct the Fate of Stem Cells. ACS Nano 2013, 7, 8379-8384 and (2) Mashinchian, O.; Bonakdar, S.; Taghinejad, H.; Satarifard, V.; Heidari, M.; Majidi, M.; Sharifi, S.; Peirovi, A.; Saffar, S.; Taghinejad, M., Cell-Imprinted Substrates Act as an Artificial Niche for Skin Regeneration. ACS Appl. Mater. Interfaces 2014, 6, 13280-13292, both of which are herein incorporated by reference in their entirety and attached as Appendices B and C. In contrast, spherical shapes for both cell and nucleus geometry were achieved for the nanopatterned substrates with shapes of keratinocytes (see FIG. 31B) and chondrocytes, in agreement with the original cell experiments.

Numerous canonical signaling pathways are activated in response to the cellular matrix and geometric cues converging on diverse transcription factors through diverse biochemical mechanisms. However, the physical transmission of such stresses through cytoplasmic-nuclear connections can remodel the chromatin structure, and this may have a more direct mechanical effect on transcription. There are very few available techniques to track the chromatin conformation variations in the nucleus, including complex super-resolution microscopy and Hi-C technology (a genome-wide method resulted from a combination of chromosome conformation capture and deep sequencing). Recent developments in the field of super-resolution microscopy have demonstrated the close relation between the chromatin conformation and various epigenetic states. Therefore, the observations of Example 3 on the effect of grooved substrates on the chromatin conformation indicate a significant role of surface topographies on change of gene expression, which leads to a substantial variation on the cell functions. More specifically, using the virtual cell approach, the variation of cell and nucleus shapes together with chromatin conformational changes during differentiation can be easily tracked. The findings can help researchers understand the mechanisms involved in shape-induced physical differentiation of stem cells.

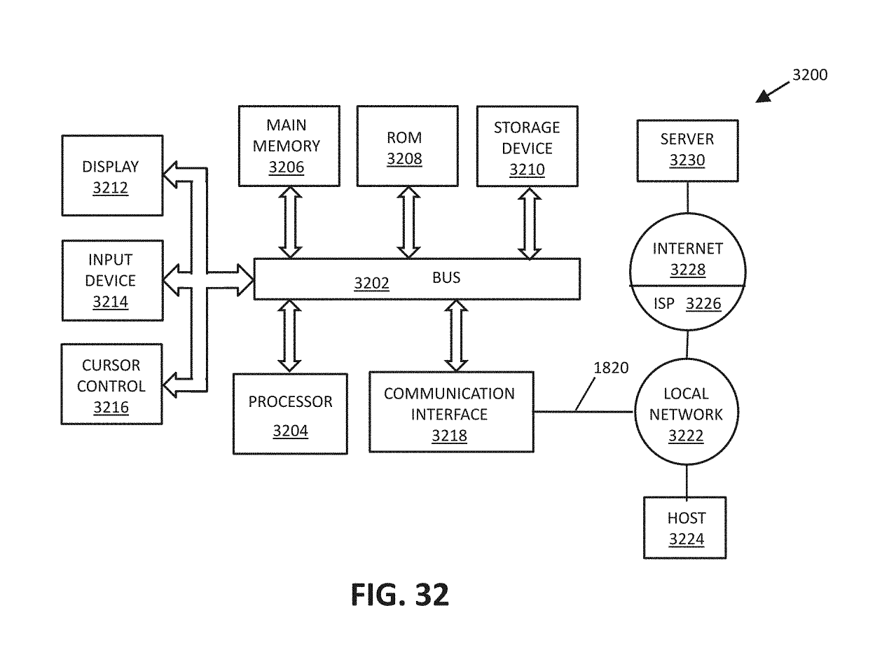

As described above, the virtual cell model can be provided through computer software. Thus, the virtual cell model can be easily accessible in standard computing devices. FIG. 32 illustrates a block diagram showing a computer system 3200 upon which aspects of this disclosure may be implemented. Computer system 3200 includes a bus 3202 or other communication mechanism for communicating information, and a processor 3204 coupled with bus 3202 for processing information. Computer system 3200 also includes a main memory 3206, such as a random access memory (RAM) or other dynamic storage device, coupled to bus 3202 for storing information and instructions to be executed by processor 3204. Main memory 3206 also may be used for storing temporary variables or other intermediate information during execution of instructions to be executed by processor 3204.

The computer system 3200 can implement, for example, one or more of, or portions of the modules and other component blocks included in the system illustrated in FIGS. 1 and 3. Examples can include, but are not limited to, obtaining cell input parameters, initializing the simulation and materials, determining if the parameters are acceptable, storing the required information during and after the simulation, post-processing the information, and/or providing an output.

The computer system 3200 can also implement, for example, one or more of, all or portions of each of the operations illustrated in FIGS. 4-28. Examples can include, but are not limited to, obtaining and/or generating information about the membrane, cytoskeleton, ECM, and chromatin fibers, focal adhesion and cell migration parameters, solvent information, other simulation information, as well as initialization of each of the cell components. All calculations described herein may also be performed or implemented by computer system 3200.

Computer system 3200 can further include a read only memory (ROM) 3208 or other static storage device coupled to bus 3202 for storing static information and instructions for processor 3204. A storage device 3210, such as a flash or other non-volatile memory can be coupled to bus 3202 for storing information and instructions.

Computer system 3200 may be coupled via bus 3202 to a display 3212, such as a liquid crystal display (LCD), for displaying information, for example, associated with the input or output parameters or other simulation information. One or more user input devices, such as the example user input device 3214 can be coupled to bus 3202, and can be configured for receiving various user inputs, such as user command selections and communicating these to processor 3204, or to a main memory 3206. The user input device 3214 can include physical structure, or virtual implementation, or both, providing user input modes or options, for controlling, for example, a cursor, visible to a user through display 3212 or through other techniques, and such modes or operations can include, for example virtual mouse, trackball, or cursor direction keys.

The computer system 3200 can include respective resources of processor 3204 executing, in an overlapping or interleaved manner, multiple module-related instruction sets to provide a plurality of modules to implement the processes illustrated in FIGS. 1-28 as respective resources of the processor 3204 executing respective module instructions. Instructions may be read into main memory 3206 from another machine-readable medium, such as storage device 3210.

In some examples, hard-wired circuitry may be used in place of or in combination with software instructions to implement one or more of the modules or operations or processes illustrated in FIGS. 1-28.

The term “machine-readable medium” as used herein refers to any medium that participates in providing data that causes a machine to operate in a specific fashion. Such a medium may take forms, including but not limited to, non-volatile media, volatile media, and transmission media. Non-volatile media can include, for example, optical or magnetic disks, such as storage device 3210. Transmission media can include optical paths, or electrical or acoustic signal propagation paths, and can include acoustic or light waves, such as those generated during radio-wave and infra-red data communications, that are capable of carrying instructions detectable by a physical mechanism for input to a machine.

Computer system 3200 can also include a communication interface 3218 coupled to bus 3202, for two-way data communication coupling to a network link 3220 connected to a local network 3222. Network link 3220 can provide data communication through one or more networks to other data devices. For example, network link 3220 may provide a connection through local network 3222 to a host computer 3224 or to data equipment operated by an Internet Service Provider (ISP) 3226 to access through the Internet 3228 a server 1130, for example, to obtain code for an application program.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study, except where specific meanings have otherwise been set forth herein. Relational terms such as “first” and “second” and the like may be used solely to distinguish one entity or action from another without necessarily requiring or implying any actual such relationship or order between such entities or actions. The terms “comprises,” “comprising,” or any other variation thereof, as used herein and in the appended claims are intended to cover a non-exclusive inclusion, encompassing a process, method, article, or apparatus that comprises a list of elements that does not include only those elements but may include other elements not expressly listed to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is not intended to be used to interpret or limit the scope or meaning of the claims. In addition, in the foregoing Detailed Description, it can be seen that various features are grouped together in various implementations. Such grouping is for purposes of streamlining this disclosure and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into this Detailed Description, with each claim standing on its own as a separately claimed subject matter.

While various implementations have been described, the description is intended to be exemplary, rather than limiting and it will be apparent to those of ordinary skill in the art that many more implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in the light of the attached claims and their equivalents. Also, various modifications and changes may be made within the scope of the attached claims.

What is claimed is:

1. A method for generating a three-dimensional virtual cell model using a virtual cell simulator, the method comprising:
receiving a plurality of cell input parameters specifying properties of a virtual cell to be included in the virtual cell model;
receiving a substrate pattern specifying an arrangement of a substrate to be included in the virtual cell model;
generating a first data set that includes initial values for the virtual cell model, the first data set including a three-dimensional model of a cell membrane of the virtual cell, a three-dimensional model of a nucleus membrane of the virtual cell, and a three-dimensional cytoskeleton network including joints with regions of the cell membrane and regions of the nucleus membrane;
calculating a configuration of the nucleus membrane by simulating physical interactions for a series of time steps between at least the substrate, cell membrane, cytoskeleton network, and nucleus membrane of the virtual cell model; and
outputting the calculated configuration of the nucleus membrane.

2. The method of claim 1, wherein the plurality of cell input parameters include values representing a cell radius and a nucleus radius.

3. The method of claim 1, wherein the plurality of cell input parameters include values representing a bending rigidity of a lipid membrane of a cell and a bending rigidity of a nucleus membrane.

4. The method of claim 1, wherein the substrate pattern is obtained using a scan of a substrate.

5. The method of claim 1, further comprising receiving a value for effective forces produced by actin polymerization in cell edges.

6. The method of claim 1, further comprising selecting a cytoskeleton type from a group consisting of a viscoelastic model, a passive cable network model, and an active cable network model.

7. The method of claim 1, further comprising receiving a topology file including a configuration of an extra cellular matrix, the configuration including values identifying an elasticity of the extra cellular matrix.

8. The method of claim 1, wherein the cell input parameters includes values representing chromatin fibers.

9. The method of claim 1, wherein the virtual cell simulator includes a simulation box, and the simulation box includes data describing a plurality of solvents and boundary conditions of associated solvent containers.

10. The method of claim 1, further comprising initializing a membrane by:
opening a topology file including membrane node position vectors and coordinates;
allocating memory for storing the topology file; and
generating vectors of membrane velocities and membrane forces.

11. A system generating a three-dimensional virtual cell model, the system comprising:
one or more processors; and
one or more non-transitory computer readable media including instructions which, when executed by the one or more processors, cause the one or more processors to:
receive a plurality of cell input parameters specifying properties of a virtual cell to be included in the virtual cell model,
receive a substrate pattern specifying an arrangement of a substrate to be included in the virtual cell model,
generate a first data set that includes initial values for the virtual cell model, the first data set including a three-dimensional model of a cell membrane of the virtual cell, a three-dimensional model of a nucleus membrane of the virtual cell, and a three-dimensional cytoskeleton network including joints with regions of the cell membrane and regions of the nucleus membrane,
calculate a configuration of the nucleus membrane by simulating physical interactions for a series of time steps between at least the substrate, cell membrane, cytoskeleton network, and nucleus membrane of the virtual cell model, and
output the calculated configuration of the nucleus membrane.

12. The system of claim 11, wherein the plurality of cell input parameters include values representing a cell radius and a nucleus radius.

13. The system of claim 11, wherein the plurality of cell input parameters include values representing a bending rigidity of a lipid membrane of a cell and a bending rigidity of a nucleus membrane.

14. The system of claim 11, wherein the substrate pattern is obtained using a scan of a substrate.

15. The system of claim 11, wherein the instructions further cause the one or more processors to receive a value for effective forces produced by actin polymerization in cell edges.

16. The system of claim 11, wherein the instructions further cause the one or more processors to select a cytoskeleton type from a group consisting of a viscoelastic model, a passive cable network model, and an active cable network model.

17. The system of claim 11, wherein the instructions further cause the one or more processors to receive a topology file including a configuration of an extra cellular matrix, the configuration including values identifying an elasticity of the extra cellular matrix.

18. The system of claim 11, wherein the cell input parameters includes values representing chromatin fibers.

19. The system of claim 11, wherein the virtual cell simulator includes a simulation box, and the simulation box includes data describing a plurality of solvents and boundary conditions of associated solvent containers.

20. The system of claim 11, wherein the instructions further cause the one or more processors to initialize a membrane by:
opening a topology file including membrane node position vectors and coordinates;
allocating memory for storing the topology file; and
generating vectors of membrane velocities and membrane forces.
